(19) United States
(12) Patent Application Publication
(10) Pub. No.: US 2015/0358810 A1
(43) Pub. Date: Dec. 10, 2015

(54) Software Configurations for Mobile Devices in a Collaborative Environment

(71) Applicant: QUALCOMM Incorporated, San Diego, CA (US)

(72) Inventors: Hui Chao, San Jose, CA (US); Dario Suarez Gracia, Santa Clara, CA (US); Gheorghe Calin Cascaval, Palo Alto, CA (US)

(21) Appl. No.: 14/300,407

(22) Filed: Jun. 10, 2014

(51) Int. Cl. H04W 8/22; H04W 52/02; G06F 9/445; H04W 4/00

(52) U.S. Cl. CPC H04W 8/22; H04W 4/001; H04W 52/0209; G06F 9/44505

(57) ABSTRACT

Methods, non-transitory processor-readable storage media, devices, and systems for improving user experience, energy consumption, and performance of a mobile device by automatically configuring applications. An embodiment method includes operations for obtaining, by a processor, operating conditions of the mobile device using an application programming interface, identifying a first of a plurality of software configurations based on the obtained operating conditions of the mobile device, wherein each in the plurality of software configurations define a set of operating parameters for the application, activating the first software configuration with respect to the application, obtaining a first portion of a task shared between a plurality of nearby collaborating devices based on the activated first software configuration, wherein the task may be processing data collectively stored across the plurality of nearby collaborating devices, and performing, by the processor, the first portion of the task using the application configured with the activated first software configuration.

### BACKGROUND

Various processing tasks may be performed by applications running on mobile devices. For example, photo summarization and classification apps may be executed on a smartphone or tablet to organize a user's photos into different groups. Instead of utilizing cloud resources (e.g., crowd servers) or other remote devices, tasks may often be performed locally by applications of a mobile device to maintain privacy and/or avoid overusing a data plan. However, executing these applications to perform such tasks may be computationally expensive, causing significant power drain and/or heat creation at the mobile device, potentially causing hardware damage when experienced for prolonged periods. As some workloads may be important but not urgent (i.e., non-urgent), mobile device users may prefer to have control over how and when applications carry-out tasks.

### SUMMARY

Various embodiments provide systems, methods, devices, and non-transitory processor-readable storage media for improving user experience, energy consumption, and performance of a mobile device by automatically and dynamically configuring applications for collaborative processing during suitable time windows based on device operating states. An embodiment method, performed by a processor of a mobile device executing an application, may include operations for obtaining operating conditions of the mobile device using an application programming interface, identifying a first software configuration of a plurality of software configurations based on the obtained operating conditions of the mobile device in which each in the plurality of software configurations define a set of operating parameters for the processor executing the application, activating the first software configuration with respect to the application, obtaining a first portion of a task shared between a plurality of nearby collaborating devices based on the activated first software configuration, wherein the task is processing data collectively stored across the plurality of nearby collaborating devices, and performing the first portion of the task using the application configured with the activated first software configuration. In some embodiments, the obtained operating conditions may include one or more of available power conditions, battery conditions, temperature conditions, available communication protocols, available networking interfaces, network connectivity, past usage data, and processor workload.

In some embodiments, performing the first portion of the task using the application configured with the activated first software configuration may any of performing the operations of the first portion of the task in a shortest time period, performing the operations of the first portion of the task until a predetermined threshold (e.g., a battery level, a temperature of the mobile device, and a location of the mobile device) is exceeded, and performing the operations of the first portion of the task in a fixed time period or periodically. In some embodiments, performing the first portion of the task using the application configured with the activated first software configuration includes exchanging data with one or more of the plurality of nearby collaborating devices using a preferred communication protocol.

In some embodiments, the method may further include receiving a command signal related to the task shared between the plurality of nearby collaborating devices, in which the command signal instructs a change of an active software configuration based on the operating conditions. In some embodiments, the method may further include deactivating the first software configuration with respect to the application in response to receiving the command signal, activating a second software configuration with respect to the application in response to the processor deactivating the first software configuration, and obtaining a second portion of the task shared between the plurality of nearby collaborating devices to be processed by the processor using the application configured with the second software configuration. In some embodiments, the second software configuration may utilize a different communication protocol than the first software configuration.

Further embodiments include a mobile computing device configured with processor-executable instructions for performing operations of the methods described above. Further embodiments include a non-transitory processor-readable medium on which are stored processor-executable instructions configured to cause a mobile computing device to perform operations of the methods described above. Further embodiments include a communication system including a plurality of mobile computing devices configured with processor-executable instructions to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a communication system including a plurality of mobile devices within proximity of each other.

FIG. 2 is a process flow diagram illustrating an embodiment method for a processor of a mobile device executing an application configured with a software configuration to process data based on the mobile device's operating conditions.

FIG. 3A is a process flow diagram illustrating an embodiment method for a processor of a mobile device executing an application configured with an economic or high-performance software configuration to process data based on operating conditions of the mobile device.

FIG. 3B is a process flow diagram illustrating an embodiment method for a processor of a mobile device executing an application configured with a fixed-time software configuration to process data within a certain period of time.

FIG. 3C is an exemplary graph of values of a function plotting time against processing quality that may be achieved using a software configuration such as described in FIG. 3C.

FIG. 4 is a process flow diagram illustrating an embodiment method for a processor of a mobile device executing an application configured with a software configuration to process a portion of a task shared between a plurality of nearby collaborating devices.

FIG. 5 is a process flow diagram illustrating an embodiment method for a processor of a mobile device executing an application to exchange messages with nearby devices when participating in a task shared between a plurality of nearby collaborating devices.

FIG. 6 is a process flow diagram illustrating an embodiment method for a processor of a mobile device executing an application configured with a software configuration to receive a command signal for adjusting software configurations when processing portions of a task shared between a plurality of nearby collaborating devices.

FIG. 7A is a component block diagram illustrating applications configured with various software configurations executing on a plurality of mobile device performing a shared task.

FIGS. 7B-7C are graphs that illustrate exemplary divisions of computing workloads corresponding to a task shared between processors of mobile devices executing applications configured with various software configurations.

FIGS. 8A-B are process flow diagrams illustrating embodiment methods for a processor of a mobile device executing an application to perform a portion of a task of summarizing media shared between a plurality of nearby collaborating devices.

FIGS. 9A-9C are component block diagrams illustrating example interfaces used by a mobile device that indicate and/or adjust various software configurations of an application according to an embodiment.

FIG. 9D is a process flow diagram illustrating an embodiment method for a processor of a mobile device executing an application configured with a first software configuration to configure the application with a second software configuration in response to user inputs.

FIG. 10 is a component block diagram of a mobile device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” and “mobile computing device” are used herein to refer to any one or all of cellular telephones, smartphones (e.g., iPhone), web-pads, tablet computers, Internet-enabled cellular or mobile telephones, WiFi enabled electronic computing devices, personal data assistants (PDA's), laptop computers, personal computers, and similar computing devices equipped with at least a processor. In various embodiments, such computing devices may be configured with a network transceiver (or other network interface) to establish a wide area network (WAN) and/or local area network (LAN) connection (e.g., an LTE, 3G or 4G wireless wide area network transceiver, a wired connection to the Internet, or WiFi). In some embodiments, such computing devices may also be configured to communicate with nearby devices via short-range transmissions, such as via a transceiver configured to exchange signals using a particular packet format, structure, and/or wireless protocol, such as Bluetooth, Zigbee, WiFiDirect, etc.

The term “non-urgent task” is used herein to refer to a task, activity, workload, routine, and/or other operation that may be performed by a mobile application and that is not critical to the functioning of the mobile device, the application, and/or the user of the mobile device. For example, a non-urgent task may be a photo processing operation. Non-urgent tasks are distinguished from system operations, such as operating system routines that control the scheduling and functioning of the various software, modules, and resources (e.g., displays, memory, interfaces, etc.) of the mobile device. Non-urgent tasks are also distinguished from emergency operations or functionalities of applications executing on the mobile device, such as emergency phone dialing operations of a phone application.

The various embodiments provide methods, devices, systems, and non-transitory process-readable storage media storing instructions for improving user experience, energy consumption, and performance of mobile devices participating in collaborative processing of tasks, for example non-urgent tasks, by automatically and dynamically configuring software configurations of applications based on device operating states of the mobile devices. Individual applications (or “apps”) executing on mobile device processors may be configured with software configurations that implement different operational characteristics, additional instructions (e.g., polling operations, etc.), and/or device resource usage (collectively referred to herein as “operating parameters”). For example, when an application is configured with a particular software configuration, a processor executing the application may be constrained to a certain processing speed and/or use of a predefined number of operating system threads. As another example, when an application is configured with another software configuration, a processor executing the application may be capable of utilizing a first resource of the mobile device (e.g., a Bluetooth transceiver) but incapable of utilizing a second resource of the mobile device (e.g., a WiFi transceiver). Processors executing applications may individually evaluate operating conditions of mobile devices against predefined information, such as policies, logic rules, conditions, and/or thresholds, to determine whether various software configurations may be employed at a given time. For example, device users or device manufacturers may set heat and power thresholds that define when an application configured with a certain software configuration may cause a processor to use high power and when it must be throttled in order to maintain the device within design, safety and/or regulatory limits. As another example, a user may set a policy that enables a processor executing an application configured with a software configuration to execute a task as fast as possible when it is daytime and/or the mobile device battery is close to full capacity.

With these software configurations of the embodiment techniques, users of mobile devices may have improved experiences, with non-urgent tasks being performed in less disruptive, more power-efficient ways. For example, a user may experience improved performance of a mobile device executing an application when the application can perform a job/task in the shortest amount of time for given battery, power, and/or heat constraints. As another example, users of mobile devices may benefit from more efficient power consumption during execution of a shared workload, with applications only consuming a minimum energy/battery allowance for a given time constraint at one or a plurality of mobile devices contributing to the shared workload.

One or more applications installed (or that may be installed) on a mobile device may be configured with one of a plurality of software configurations with specific operating parameters that may be predefined by users, developers, and/or device manufacturers. One exemplary software configuration may be a “high-performance” software configuration that enables a processor executing an application to complete tasks associated with the application as soon as possible, but that requires more resources and generates more heat. Another exemplary software configuration may be an “economic” software configuration that may cause the processor executing the application to execute tasks associated with the application in a normal (or default) fashion until a power threshold or heat threshold is exceeded, at which time the execution of the application by the processor may be paused until re-entry conditions are met. For example, while in the economic software configuration, the processor executing the application may periodically compare the current device temperature to a predefined heat threshold, and may cause a task to enter a suspended state for as long as the temperature exceeds the threshold. Another exemplary software configuration may be a “fixed-time” software configuration that controls resource usage by the processor executing the application based on a prediction of how the current resources available in the device may be utilized over a predefined time period. Such a fixed-time software configuration may balance speed and quality of processing of data associated with the application based on the available time to process a workload. For example, the processor executing the application may determine that rendering settings in a video game engine may need to be reduced in order to maintain a game throughout an airline flight. As another example, processing speeds of a processor executing an image classification application may be different for images with different resolutions, such that with higher image resolution images the processing quality may be better but may take a longer time to classify each image. Another exemplary software configuration may be a “background power-saving” software configuration that, similar to the economic software configuration, potentially uses slower processing while producing less heat, but may use different thresholds for the processor executing the application to pause operations of a task associated with the application. For example, the background power-saving software configuration may be used when the device executing the application is plugged into a power source (or the battery is full), when it is late at night, or when no other applications or tasks are actively executing on the mobile device's processor (idle state). In some embodiments, when the processor executing the application is configured with the background power-saving software configuration (e.g., when a user selects it via an interface, etc.), a user may choose a fixed time for the processor to run the application when connected to a power source (e.g., late at night).

In various embodiments, multiple nearby mobile devices within wireless communication range of one another (referred to herein as “collaborating devices”) may execute applications configured with software configurations to process a shared task in a collaborative computing environment. For example, a plurality of nearby collaborating devices placed on a charging table (e.g., a hotel table, etc.) may utilize applications configured with various software configurations to collectively process a single data set as a computing cluster. In such environments, the nearby collaborating devices executing the applications may contribute differently to the shared task based on their different software configurations, exchanging data via wireless communication links, such as WiFi or Bluetooth links. For example, nearby collaborating devices with more resources (e.g., higher battery charge states, a faster processor, more capable communication protocols, etc.) may be configured to execute applications configured with “high-performance” software configurations and thus may be assigned larger, more frequent, and/or more complex workloads of a shared task, while other devices with fewer resources may execute applications with “economic” or “power-saving” software configurations and be assigned smaller, less frequent, and/or less complex workloads of the shared task. As another example, a particular mobile device may be configured to perform a limited number of operations to contribute to a shared workload when the particular mobile device has less available battery power than the other contributing devices. Existing peer-to-peer (P2P) communication techniques or protocols may be used to implement communications between nearby collaborating devices (e.g., existing P2P file protocols, media transfer schemes, etc.), and may include transferring metadata and media files between the collaborating devices. In some embodiments, operations of shared tasks may be assigned to nearby collaborating devices in a round-robin fashion when the devices are not configured with the same software configuration.

The following is an example to illustrate embodiment software configurations used for processing a shared task. During an out-of-town trip, smartphones of family members may be used to take digital photos during the daytime. Due to connectivity or other issues (e.g., poor data plan), the photos may not get immediately distributed amongst the various smartphones nor to cloud services (e.g., online file lockers, etc.). At night in a hotel the smartphones may be placed within communication range of each other, such as on a table for charging. Photo summarization applications may be actively executing on the processors of each of the smartphones. Each of the applications may be configured with different software configurations based on individual user preferences and/or operating conditions of the individual mobile devices (e.g., available battery power, device temperature, etc.). Recognizing that the devices are capable of communicating with another, the processors executing the applications on each smartphone may begin peer-to-peer communications with each another, exchanging media files (e.g., via Bluetooth connections) so that some or all of the photos taken by all the smartphones may be consolidated, organized, and summarized via the applications. Based on their individual software configurations, the applications on the smartphones may be used by the smartphones to collaborate in assigning tasks according to capabilities and resources so that the smartphones may process different numbers of photos, with more capable smartphones (e.g., faster processor, more memory, faster data connection, etc.) automatically being assigned more photos to process. After the photo summarization shared task is completed, each family member may use their respective smartphone to see the photos that were captured on the other family members' smartphones that day.

In some embodiments, one of the nearby collaborating devices may be designated as a “master” device to control the performance of a shared task by orchestrating the operations and/or software configurations of the applications executing on other collaborating devices. For example, a master device may check the current software configuration of an application executing on another collaborating device, estimate that device's capabilities (e.g., available battery power), and assign workloads to the collaborating device's processor executing the application accordingly. The master device may evaluate processing and memory costs, communication speeds, and various other operating conditions based on the software configurations of the applications executing on the collaborating device when dividing the workload of a shared task. For example, when configured with a power-saving software configuration, the master device may assign workloads of a shared task to collaborating devices that are within a certain distance (or proximity) of the other collaborating devices so that data can be exchanged via short-range wireless signals (e.g., Bluetooth) in order to minimize the costs of transferring files.

The master device may organize the shared tasks among the nearby collaborating devices based on the type of task. For example, for certain simple shared tasks, no master device may be needed, as the nearby collaborating devices may easily divide or concurrently perform overlapping workloads. For some complex operations, such as automatic stitching or other computational photography techniques, a master device may be identified among the nearby collaborating devices as the most capable device based on its operating conditions (e.g., fastest processor, most battery life, plugged-in to a power source, most memory, etc.) and/or the current software configuration of its application, and thus may be designated the best device for expending energy organizing the shared tasks. In some embodiments, the master device may be designated based on user inputs, such as a user input to begin a shared task on a particular smartphone.

In some embodiments, applications executing on collaborating devices participating in a shared task may be configured with a common software configuration. In other words, for some shared tasks, processors executing participating applications may be required to activate a consistent software configuration prior to starting performance of the shared task. For example, a master device may transmit messages to the various collaborating devices that cause the applications executing on each to be configured with a “high-performance” software configuration, an “economic” software configuration, or another software configuration that activates communication protocols for improved file transfers between the devices. In some embodiments, collaborating devices may be configured to report (or broadcast) the current software configurations of applications executing on their processors so that other devices, such as the master device, may identify the current software configurations and potentially transmit messages that cause changes to their current software configurations (e.g., change thresholds, change the active software configurations, etc.). In some embodiments, users of the collaborating devices may be required to provide user inputs to authorize changes to software configurations of applications, such as by pressing an “OK” graphical user interface button rendered on his mobile device in response to receiving a command signal from a master device. In some embodiments, in response to a processor adjusting the software configuration of an application executing on the processor, the processor executing the application may be configured to report such an adjustment to nearby collaborating devices.

In some embodiments, shared tasks may be paused and/or placed on a waiting list in response to adjustments of software configurations by various applications participating in the shared tasks. Further, a warning message may be displayed to a user of a mobile device in response to the application being configured with a different or more expensive software configuration before a processor executing the application starting operations of a shared task and/or before a suspended task continues after pausing due to a software configuration adjustment.

In some embodiments, software configurations of applications may cause processors to be configured to use various resources and functionalities of mobile devices, such as different sensors and/or transceivers (e.g., Bluetooth, NFC, Zigbee, WiFi, Ultrasound, etc.). For example, a processor executing an application configured with a first software configuration may utilize a first communication protocol and/or transceiver, but the processor executing the application may utilize a second communication protocol and/or transceiver when configured with a second software configuration. In this way, based on the operating conditions of the mobile device, processors executing applications may be configured to utilize more efficient resources and/or be capable of performing more workloads of shared tasks.

In general, processors executing applications may be configured to evaluate current operating conditions of the mobile device to identify which software configuration to use (or activate) for the applications at a given time. Processors executing applications may obtain various contextual information of the mobile device, such as a time of day (e.g., daytime, nighttime, etc.), available power (e.g., battery charge level, whether the device is plugged-in to a power source, etc.), hardware or resources used (e.g., transceivers, memory, processor(s), etc.), and the state of other tasks or applications executing on the mobile device (e.g., no other tasks are running, system idle, etc.). Such operating conditions may be current information and/or estimated information based on current conditions of the mobile device. The processors executing the applications may compare the obtained operating conditions to predefined data stored on the device and associated with various software configurations (e.g., profiles). For example, a processor executing an application may compare a projected battery power consumption of a certain task scheduled to be processed in the near future to a stored profile to identify that the application may be configured with a particular software configuration to best conserve the mobile device battery or maintain a certain quality of service (QoS). In some embodiments, profiles may include past application performance data, such as past processor, power, and other resource usage (e.g., 3G/4G cellular network connections, WiFi transceiver, Bluetooth transceiver, etc.). In this way, the processor executing the application may estimate the potential requirements for processing a task (e.g., predict power consumption, etc.) and determine a software configuration pre-associated as appropriate for such predicted requirements. In various embodiments, each application capable of being executed on the mobile device may be associated with individual profiles that may be used to identify different software configurations for each application based on operating conditions of the mobile device.

Policies that set default software configurations, such as information stored in profiles, may be chosen by manufacturers, developers, and/or the user. In some embodiments, a user may utilize a user interface (e.g., a graphical user interface of “GUI”) to set or modify a default software configuration for a particular application. In some embodiments, such a GUI may provide warning messages to the user when the user or an application autonomously chooses a more expensive default software configuration. For example, the processor executing the application may prompt the user to authorize a proposed change from a default software configuration by rendering a popup window that requests a user input for confirmation. Further, the user may choose the priority of each of the tasks/applications to be used to choose between multiple actions awaiting execution. Priority lists may be based on the last time a certain kind of task was executed, the least amount of time a task may require to be executed, etc.

In some embodiments, processors executing applications may be configured to automatically abandon user preferences or change (or “side-step”) user-defined policies using context-aware logic (or engines). For example, when a mobile device is charging at night, an application may not be configured to enter an economic software configuration as directed by a previous user input, but instead may be configured to enter the high-performance software configuration. As another example, a processor executing an application may increase a heat threshold when plugged into a power source at night and thus unlikely to be held by the user (e.g., a high heat threshold that won't allow the device to burn a table, etc.). As another example, contrary to a user preference, a processor executing an application may switch the application from an economic software configuration to a high-performance software configuration in response to determining that the available battery power is near full capacity in the daytime. Such determinations of processors executing applications may occur only when there is available information, such as past usage information stored on the mobile device, that provides adequate assurances or likelihoods that such software configuration changes may not be too risky or otherwise inhibit the future performance of the application and/or the mobile device in general. For example, changing an application from an economic software configuration to a high-performance software configuration may not occur when the processor executing the application does not have access to stored historical information that indicates whether the user is likely to plug the mobile device into a power outlet in the near future.

In various embodiments, processors executing applications may be configured to utilize an application programming interface (or API), user-level library, or a run-time system for implementing software configurations. Application developers may design applications with internal logic that may cause a processor to call or otherwise invoke various APIs in order to switch between software configurations for the applications. In particular, without the assistance of an operating system scheduling routine or other similar central manager, API commands may be used to obtain the operating conditions of the mobile device (e.g., battery state, data plan information, device temperature, etc.), and processors executing applications may compare that obtained information to predetermined quality of service (QoS) information related to the applications in order to determine whether one of various software configurations may be enacted. Therefore, unlike techniques that may require an operating system of the mobile device or a user input to select or determine software configurations, processor executing applications may make such determinations based on the obtained information and implement selected software configurations independently. In various embodiments, software configurations and related APIs may be enabled via the use of programming languages, such as Multicore Asynchronous Runtime Environment (MARE) or Halide.

The various embodiments relate to application-level software configurations that may be used to control operations of a mobile device processor executing an application, particularly the processing of data for non-urgent tasks shared between nearby collaborating devices. Processors executing applications may independently and individualistically configure their operating parameters based on software configurations of the applications without influence from any central or system-wide routine, operating mode, and/or other control logic of the mobile device. Thus, embodiment software configurations are not the same as conventional system-wide (or computer-wide) modes, logic, and/or configurations that affect all operations of a computing device, such as laptop “eco” or power-savings modes. Instead, the embodiment software configurations may be utilized to discretely adjust the operating parameters and operations of processors executing individual applications of a mobile device with regard to particular tasks. Further, unlike conventional techniques, embodiment techniques may enable processor executing applications to identify appropriate software configurations for the applications to be configured with at a given time based on evaluating operating conditions specific to mobile processing environments, such as the power implications of using different sensors (e.g., cellular, Bluetooth, NFC, Zigbee, WiFi, Ultrasound, etc.) for exchanging signals with nearby devices in a collaborative computing environment.

Additionally, unlike conventional task scheduling techniques, the embodiment techniques do not schedule processing of applications, but instead utilize various software configurations to enable processors executing applications to perform tasks in safe and convenient ways with reference to power consumption and device temperatures. The embodiment techniques do not prioritize the execution of different applications based on profiles, but instead may compare current operating conditions of a mobile device to information within profiles for individual applications in order to identify respective software configurations (and thus operating parameters) for enabling the convenient execution of each of the individual applications.

For simplicity, the following descriptions may refer to applications performing actions without reference to a processor. However, as applications necessarily utilize processor(s), circuitry, and other resources (e.g., operating system, memory, etc.) of a mobile computing device for loading and executing of such actions, it should be appreciated that execution of the applications by device processors, circuits and resources is intended in the following descriptions.

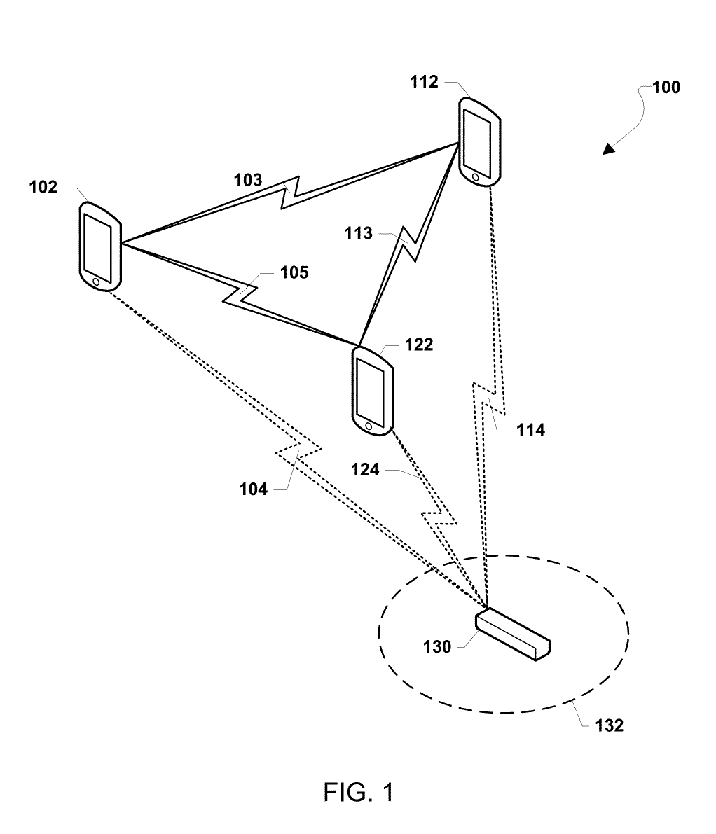

FIG. 1 illustrates a communication system 100 including a plurality of devices within proximity of each other. In particular, the system 100 may include a first mobile device 102, a second mobile device 112, and third mobile device 122. For example, the communication system 100 may include a plurality of smartphones associated with one or more users. Each of the mobile devices 102, 112, 122 may include various functionalities for obtaining and processing various types of data, such as application and/or communications data. For example, the mobile devices 102, 112, 122 may include various wireless transceivers, such as cellular, Bluetooth, Peanut, WiFi, RF, and/or Zigbee transceivers (or radios), coupled to their respective processors. Using such transceivers, the mobile devices 102, 112, 122 may be configured to exchange peer-to-peer transmissions with one another via short-range communication links 103, 105, 113. For example, the first mobile device 102 may be configured to transmit Bluetooth packets via the communication link 103 for receipt by the second mobile device 112. Data exchanged between the mobile devices 102, 112, 122 via the communication links 103, 105, 113 may be associated with applications executing on the individual mobile devices 102, 112, 122. For example, the first mobile device 102 may transmit digital imagery files (e.g., photographs, movie files, etc.) to the second mobile device 112 for processing via a media summarization application.

In some embodiments, the communication system 100 may also include a wireless router 130 (e.g., a WiFi router) associated with a local area network 132 (LAN). The mobile devices 102, 112, 122 may be configured to communicate with the wireless router 130 via wireless communication links 104, 114, 124, and may be configured to exchange peer-to-peer communications via the local area network 132. In various embodiments, the mobile devices 102, 112, 122 may be configured to use different communication links for exchanging data with different devices. For example, due to operating with a software configuration with operating parameters restricting power consumption, the first mobile device 102 may only transmit data to the second mobile device 112 via the short-range communication link 103. As another example, when the third mobile device 122 has deactivated its short-range transceiver due to another software configuration, the second mobile device 112 may transmit data to the third mobile device 122 via the local area network 132 by transmitting data via the wireless router 130 using the communication link 114.

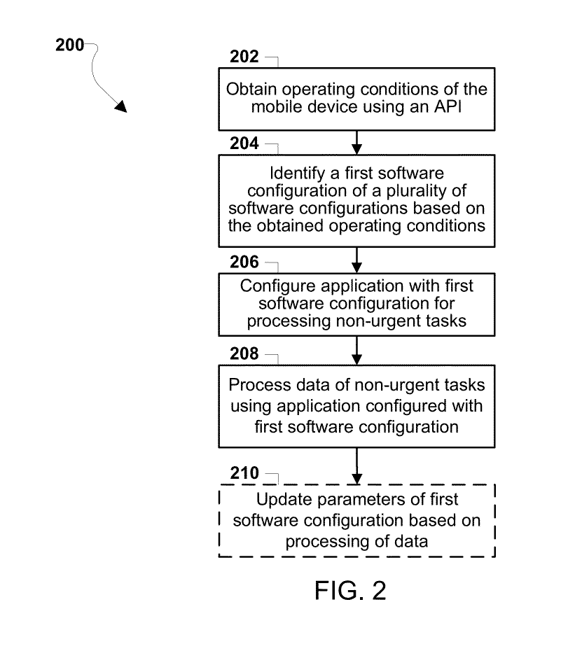

FIG. 2 illustrates an embodiment method 200 for a mobile device processor executing an application configured with a software configuration to process data based on the mobile device's operating conditions. As described above, using software configurations, processor executing applications may be configured to execute operations of tasks using various operating parameters (e.g., processing speed, quality, etc.). Such software configurations of applications may be automatically and dynamically invoked by code within the applications based on various contextual information from the mobile device. For example, at runtime, an application written using the Multicore Asynchronous Runtime Environment (MARE) programming language may be configured so that a processor executing the application may check for certain operating conditions within the mobile device in order to determine whether to switch software configurations of the application to improve efficiency, slow power usage rates, and/or adjust the communication resources (e.g., radios, etc.). The operations of the method 200 may enable the automatic, autonomous adjustment at the application-level of the manner in which tasks are performed by processors executing applications.

In block 202, the processor executing the application may obtain operating conditions of the mobile device using an application programming interface (API). In other words, at runtime, the processor executing the application may invoke API commands that query up-to-date information about the mobile device that may not otherwise be available to the application. The obtained operating conditions of the mobile device may include data that indicates the activities and status of the device at a given time, and may include one or more of available power conditions, battery conditions, temperature conditions, available communication protocols, available networking interfaces (e.g., transceivers, etc.), network connectivity and communication conditions (e.g., cellular network data plan information, in-use transceiver chains, available bandwidth, cellular network conditions/traffic, signal strength, etc.), past usage data, and processor workload. For example, the obtained data may indicate that the mobile device's available communication protocols include one or more of cellular, Bluetooth, NFC, Zigbee, WiFi, and Ultrasound, etc.

In some embodiments, the processor executing the application may continuously or periodically obtain the operating conditions of the mobile device using the API so that up-to-date conditions (or current conditions) are available to the application during its execution on the mobile device. For example, the mobile device processor via the application may poll operating conditions every few seconds, minutes, etc. during its execution in order to determine whether to periodically or continuously configure its software configuration accordingly.

The API may be a set or library of commands, calls, and/or routines that may be invoked by the processor executing the application in order to access system-level information of the mobile device. Such an API may be developed by the manufacturer of the mobile device and/or a third-party and may be designed to enable various applications to independently interface with the operating system and/or other logic that controls the various components and software of the mobile device. For example, a certain API command may be used to cause the operating system of the mobile device to return to the processor executing the application a variable value and/or perform an operation that the processor executing the application would not otherwise have access to without the API command. In various embodiments, the API may be a user-level library or a run-time system that may be utilized by the processor when executing various applications. In various embodiments, the API may be enabled for use by the processor executing the application via the use of the MARE and/or Halide programming languages.

In various embodiments, the operating conditions may include data that indicates whether the mobile device is plugged into a power source (e.g., a power outlet), the time of day, the date (e.g., day, month, year, etc.), the idle state of the mobile device system (e.g., operating system), location information (e.g., GPS coordinates, etc.), scheduled operations (e.g., applications to be performed via the mobile device at a given time in the future, etc.), calendar data, other available functionalities or resources of the mobile device (e.g., available memory, available processor resources, software installed on the mobile device, etc.), unavailable functionalities or resources of the mobile device (e.g., deactivated transceivers, suspended routines, etc.), and the number of tasks or applications currently running on the device. In some embodiments, the operating conditions may also indicate whether there are nearby devices with which the processor executing the application can communicate, such as smartphones within Bluetooth communication range of the mobile device that have been paired via a Bluetooth protocol, etc. In some embodiments, the processor executing the application may utilize a context-aware engine or algorithm to observe the various operating conditions of the mobile device and determine weights or importance assessments of the various conditions that may be used when identifying the most appropriate software configuration at a given time.

In some embodiments, the operating conditions may also include any inputs, preferences, settings, and/or selected options set by the user of the mobile device. For example, the operating conditions may include information indicating that the user has previously input a preference for the software configuration that an application should be configured with for a particular time of day, battery power, device temperature reading, etc. The processor executing the application may utilize such user-supplied preferences in context of other operating conditions, such as current workload on a processor, in order to determine appropriate software configurations for the application. In some embodiments, user-supplied information may or may not affect the determinations of block 204 described below. In other words, user preferences or policies may be “side-stepped” by the processor executing the application based on an evaluation of some or all of the operating conditions at a given time. For example, operating conditions indicating a dangerously high device temperature may cause the processor executing the application to configure the application with an economic software configuration regardless of a user preference for high-performance software configuration.

In block 204, the processor executing the application may identify a first software configuration of a plurality of software configurations based on the obtained operating conditions of the mobile device. The first software configuration may be the set of operating parameters that is best suited or most appropriate for enabling the processor executing the application to perform a task at a given time and under the current conditions. To make the identification, the processor executing the application may analyze individual operating conditions, such as a high priority condition (e.g., very low/high battery power, very high device temperature, etc.), or any combination of operating conditions. For example, the processor executing the application may identify a software configuration that permits aggressive processing of data when the mobile device has full battery power, when it is late at night, and/or there are no other tasks or applications executing on the mobile device. As another example, the processor executing the application may identify a software configuration that causes slower processing when the battery is not fully charged and/or the processor of the mobile device is not idle.

As described above, the first software configuration may be any of a predefined set of software configurations, such as an economic software configuration used to balance processing of data by a processor executing the application with conserving resources of the mobile device (e.g., little battery power consumptions, little heat generation, etc.), a high-performance software configuration used to cause the processor executing the application to perform a task associated with the application as fast as possible without regard to the use of device resources (e.g., high power consumption, high heat generation, etc.), a fixed-time software configuration used to cause the processor executing the application to complete application tasks with variable quality of service but within a set period of time, and a power-saving software configuration used to cause the processor executing the application to perform operations associated with the application in a slow, low-heat generating manner, such as when the mobile device is plugged into a power outlet.

In some embodiments, each software configuration may be associated with different sets of operating parameters for executing the application that are each related to particular operating conditions of the mobile device. For example, the first software configuration may utilize a first battery power threshold when the mobile device is at a first location based on GPS coordinates and may utilize a second battery power threshold when the mobile device is at a second location. In this way, even when configured with the same particular software configuration, the processor executing the application may experience different behaviors based on changing operating conditions of the mobile device.

In some embodiments, to identify the first software configuration, the processor executing the application may utilize one or more profiles that correlate certain operating conditions of the mobile device with parameters, guidelines, thresholds, routines, and other operating constraints for the processor executing the application to observe (i.e., software configurations). For example, the processor executing the application may utilize a power profile that may correlate past (or historical) power usage by the processor executing the application with a suggested set of operating parameters that are well-suited for subsequent similar power usage. Such profiles may be used by the processor executing the application to predict future activities and resource usage of the application, such as by matching current activities indicated by the obtained operating conditions with contextual information stored within the profiles (e.g., previous activities and mobile device operating conditions, etc.).

In some embodiments, the processor executing the application may identify the first software configuration by comparing the current operating conditions of the mobile device to predefined quality of service (QoS) requirements. In particular, the processor executing the application may determine the quality of service of the application may achieve when configured with the operating parameters of the first software configuration and compare this determined quality of service to predefined thresholds in order to determine whether the first software configuration may be used.

In some embodiments, the processor executing the application may be configured to identify the first software configuration based on user preferences or settings. For example, the obtained operating conditions may indicate that a user has previously selected a certain software configuration to be used for configuring the application (e.g., a policy indicating a high-performance software configuration should be used at a certain time of day or available battery power, etc.). However, the processor executing the application may be configured to side-step user settings in order to identify a most appropriate software configuration for a given operating context. For example, when a user preference for the application to be configured with first software configuration is estimated to exceed an available power allowance when used to process a certain task, cause processor activity above a predefined threshold, and/or reduce the efficiency of the processor executing the application below an acceptable predefined level, the processor executing the application may ignore the user preference and identify the first software configuration based on other operating conditions alone (e.g., environment context awareness).

In block 206, the processor executing the application may configure the application with the first software configuration for processing non-urgent tasks. In other words, the processor executing the application may activate the first software configuration. For example, via the application configuration with the first software configuration, the processor may set its processing speed or the rate at which processing cycles are utilized based on the operating parameters defined by the first software configuration. Configuring the application with the first software configuration may include setting various thresholds that may be used by the processor executing the application to determine whether to start or stop performing operations. As described below, the first software configuration may include device temperature and/or battery power threshold values that may be evaluated by the processor executing the application during its execution to determine whether the operations associated with the application may be suspended, rescheduled, or otherwise have an adjusted execution rate. In some embodiments, configuring the application with the first software configuration may include the processor activating or deactivating networking interfaces (e.g., transceivers) and/or using or discontinuing the use of certain communication protocols. For example, the first software configuration may cause the processor executing the application to stop evaluating Bluetooth packets or alternatively may cause the processor executing the application to begin utilizing a WiFi transceiver. In some embodiments, the first software configuration may increase or decrease use of the processor of the mobile device when executing the application, such as by requesting additional or fewer processing cycles or operating system threads.

In various embodiments, the mobile device processor executing the application may continually and dynamically adjust software configurations as the operating conditions may change from time to time. For example, when the mobile device is not charging, the processor may configure an application to run in power saving software configuration, but when the battery is fully charged and still plugged in to power, the processor may change the application's software configuration to a high performance software configuration.

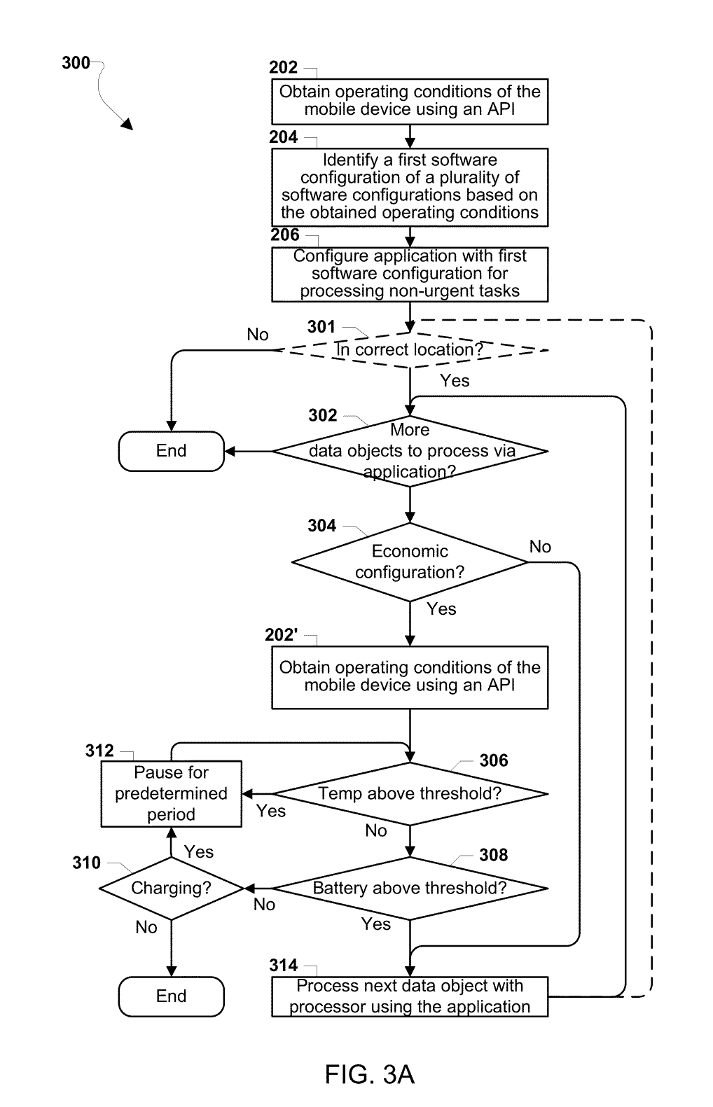

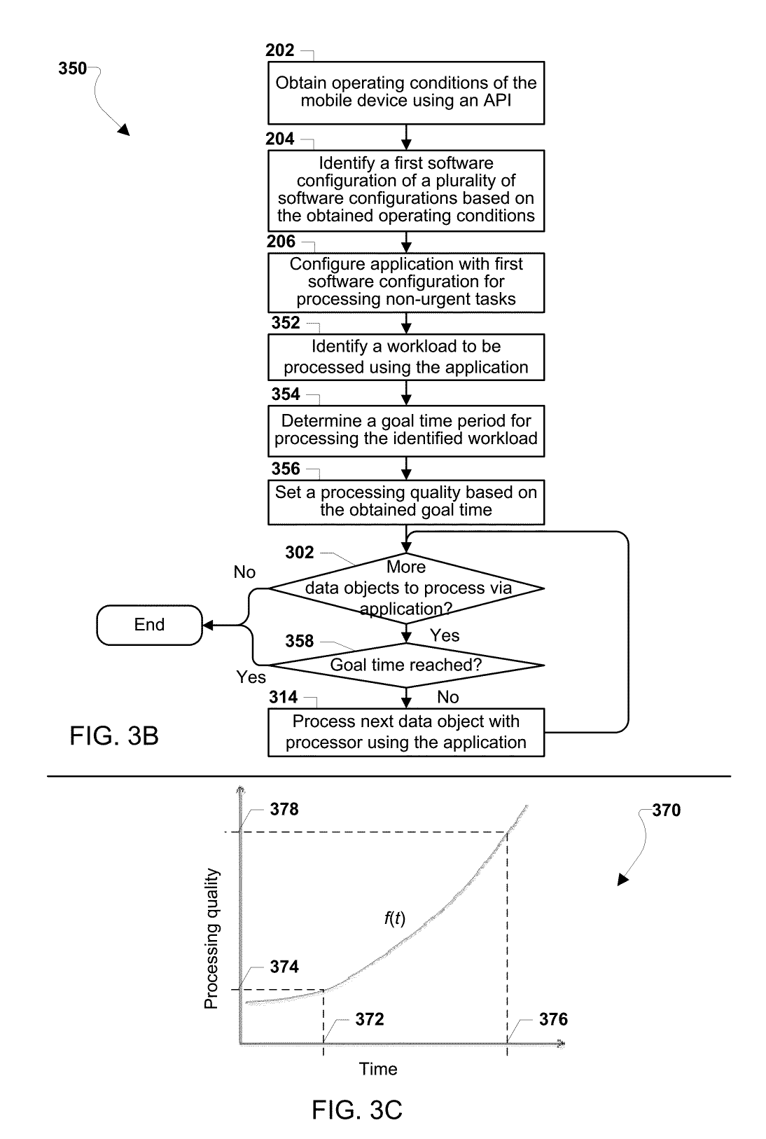

In block 208, the processor executing the application configured with the first software configuration may process data of non-urgent tasks using the application. For example, when the application is a media summarization application (or app), the processor executing the application may begin evaluating media files stored on the mobile device in order to classify, categorize, and/or organize the media files. The manner of processing the data by the processor executing the application may be controlled by the first software configuration. In particular, the first software configuration may control the speed at which the data is processed by the processor executing the application, the quality of processing of the data, the amount of time that the processor executing the application may process the data, the total amount of data processed, the number of batches of data processed (i.e., whether the total workload is divided into individual batches of data), the interval of uninterrupted processing of the data (e.g., whether there are pauses in between batch operations, etc.), and the functionalities of the mobile device that are used when processing the data (e.g., message buffers, auxiliary processors, memory units, transceivers, communication protocols, sensor units, etc.). As an example, when configured with a high-performance software configuration, the processor executing the application may perform operations for summarizing a set of digital media files as fast as possible without regard for heat generation and/or battery power levels. FIGS. 3A-C illustrate various methods for the processor processing data using applications configured with particular software configurations.

In optional block 210, the processor executing the application may update parameters of the first software configuration based on processing the data. For example, the processor executing the application may update threshold values associated with the first software configuration (e.g., activity threshold, battery threshold, heat threshold, etc.) based on the effect of processing the data on the operating conditions of the mobile device. In various embodiments, the processor executing the application may obtain additional, more up-to-date operating conditions of the mobile device, similar to the operations described above with reference to block 202, in order to perform the updating operations in optional block 210. For example, after the data associated with the application is processed with the processor via the application that is configured with the first software configuration, the processor executing the application may use API commands to query battery state, device temperature, and other operating conditions to identify whether the first software configuration is adequate for similar conditions encountered in the future.

FIGS. 3A-3B illustrate embodiment methods for a processor to process data via an application configured with different types of software configurations. In particular, based on an active software configuration of the application (e.g., economic, high-performance, etc.), the processor executing the application may perform various checking operations to determine whether to continue processing data, as well as how to process data. For example, when in the application is configured with an economic software configuration, the processor executing the application may perform wait operations in response to determining a temperature is above a threshold.

For simplicity purposes, the term “data object” is used in the following descriptions to refer to discrete data elements that may be processed by a processor executing an application as part of a task. However, it should be appreciated that references to data objects may also include instructions and/or operations to be performed by the processor executing the application as part of the task.

FIG. 3A illustrates an embodiment method 300 for a mobile device processor executing an application to process data when the application is configured with an economic or high-performance software configuration based on operating conditions of the mobile device. As described above, the application executed by the processor may be configured with an economic software configuration in order to preserve battery power and cause a lower level of heat generation in the mobile device, whereas the high-performance software configuration may simply enable the processor executing the application to process data as fast as possible.

The operations in blocks 202-206 may be similar to the operations in like numbered blocks described above with reference to FIG. 2. In optional determination block 301, the processor executing the application may determine whether the mobile device is within a predefined (or “correct”) location for performing the operations of the application configured with the software configuration. The mobile device processor may evaluate various information within the obtained operating conditions against stored data associated with the application and/or the software configuration to determine whether the mobile device has entered (or is still within) a location appropriate for the application and/or a workload of the application. The mobile device processor may identify locations (e.g., predefined or current) based on GPS coordinates, service set identifiers (SSID) or other access point identifiers to which the mobile device has connected or identified as within proximity. For example, the mobile device processor executing the application may compare recently obtained GPS coordinates with predefined GPS coordinates associated with the application to determine whether the mobile device is in a correct place for joining in a workload shared by a plurality of other mobile devices. As another example, the mobile device processor executing the application may be configured to share a workload of taking pictures of a sporting event with nearby devices (e.g., smartphones of attendees sitting next to the user of the mobile device, etc.) only while the mobile device is within a stadium, and thus may check whether its current location is in the stadium before commencing with the application operations. In response to determining the mobile device is not within a predefined location appropriate for the operations of the application configured with the software configuration (i.e., optional determination block 301=“No”), the processor executing the application may end the operations of the method 300.

In response to determining the mobile device is within the predefined location appropriate for the operations of the application configured with the software configuration (i.e., optional determination block 301=“Yes”), the processor executing the application may determine whether there are more data objects to process via the application configured with the first software configuration in determination block 302. For example, the processor executing the application may determine whether it has processed all data within a current workload of a task shared by a plurality of nearby collaborating devices. When the processor executing the application first performs the operations of determination block 302, it may determine whether there is a first data object to process. In response to determining there are no more data objects to process via the application (i.e., determination block 302=“No”), the processor executing the application may end the operations of the method 300. In other words, once the data objects of a task performed by the processor executing the application have all been processed, the application may be suspended, closed, or otherwise removed from the active processing queue of the mobile device processor. In some embodiments, the processor executing the application may deactivate the first software configuration in response to determining there are no more data objects to process (i.e., determination block 302=“No”).

In response to determining there are more data objects to process via the application (i.e., determination block 302=“Yes”), the processor executing the application may determine whether the application is configured to operate with an economic software configuration with the first software configuration in determination block 304. For example, the processor executing the application may evaluate a stored code or variable indicating the identity of the current software configuration to determine whether the economic software configuration is active at a given time. The processor executing the application may make this determination in order to determine whether the additional operations associated with the economic software configuration (i.e., the operations in blocks 202′, 306, 308, 310, 312) are needed to be performed or whether these additional operations may be bypassed due to the application being configured with the high-performance software configuration. In response to determining that the application is not configured with the economic software configuration (i.e., determination block 304=“No”), the processor executing the application may be configured to process data objects as fast as possible and without checking the current temperature and/or battery power (i.e., operate with the high-performance software configuration). For example, when operating with the high-performance software configuration, the processor executing the application may be configured to execute operations associated with the application with high processing quality and/or high speed processing, regardless of the computational and/or battery power expense or the amount of remaining battery power.

In response to determining that the application is configured with the economic software configuration (i.e., determination block 304=“Yes”), similar to the operations described above with reference to block 202, the processor executing the application may once again obtain the current operating conditions of the mobile device using the API in block 202′. In this way, the processor executing the application may continually determine the up-to-date operating conditions of the mobile device in order to determine whether various thresholds indicated by the first software configuration have been exceeded during the processing of data. For the first execution of the operations in determination block 304, the processor executing the application may not be required to obtain the device operating conditions as the previously obtained information may still be up-to-date.

In determination block 306, the processor executing the application may determine whether a current temperature of the mobile device indicated in the obtained operating conditions is above a predefined temperature threshold. In other words, based on the operating parameters associated with the economic software configuration, the processor executing the application may determine whether the current device temperature from the obtained operating conditions information exceeds the temperature threshold of the first software configuration. In response to determining that the current temperature of the mobile device is above the predefined temperature threshold (i.e., determination block 306=“Yes”), the processor executing the application may pause for a predetermined period, such as a number of seconds, minutes, etc. in block 312, and then may continue with the temperature checking operations in determination block 306. For example, the operations of the application may be suspended by the mobile device processor for a period of time. The predetermined period of time may be identified by the processor executing the application as a time period adequate for allowing a certain amount of heat dissipation in mobile device components.

In response to determining that the current temperature of the mobile device is not above the predefined temperature threshold (i.e., determination block 306=“No”), the processor executing the application may determine whether the current available battery power from the obtained operating conditions is above a predefined battery threshold based on the parameters of the first software configuration in determination block 308. For example, the processor executing the application may compare the current battery power indicated in the obtained operating conditions to the predefined battery threshold for the economic software configuration.

In response to determining that the current battery power is not above the predefined battery threshold (i.e., determination block 308=“No”), the processor executing the application may determine whether the mobile device is currently charging in determination block 310. For example, the processor executing the application may determine whether the mobile device is currently plugged into a wall power outlet based on the obtained operating conditions. In response to determining that the mobile device is currently charging (i.e., determination block 310=“Yes”), the processor executing the application may pause the application in block 312, such as by suspending execution of the application for a predefined number of seconds, before continuing with the temperature checking operations in determination block 306. However, in response to determining that the mobile device is not currently charging (i.e., determination block 310=“No”), the processor executing the application may stop the execution of the method 300. In other words, when there is an inadequate amount of battery power and no other available power source, the processor executing the application may determine it may not continue to process the data based on the parameters of the first software configuration.

In response to determining that the current battery power is above the predefined battery threshold (i.e., determination block 308=“Yes”), or in response to determining that the processor executing the application is not configured with the economic software configuration (i.e., determination block 304=“No”), in block 314, the processor executing the application may process a next data object using the application. For example, the processor executing the application may perform any number of operations on a next data object in a set of data objects to be processed, such as performing analysis, decryption, encryption, classification, image recognition, annotation, sorting, and/or other operations with regard to the next data object. When the operations in block 314 are first performed, the next data object may be the first data object in a task. The mobile device may continue with the operations in determination block 302. In some embodiments, the mobile device processor may optionally continue with the operations in optional determination block 301 in response to processing the next data object with the operations in block 314. In this way, the mobile device processor executing the software may continually monitor whether it is within the appropriate location for performing operations, such as processes shared between multiple devices at a time-sensitive or event-centric activity (e.g., a sporting event, interest group meeting, etc.).

FIG. 3B illustrates an embodiment method 350 for a processor executing an application configured with a fixed-time software configuration to process data within a certain period of time. As described above, the processor executing the application may configure itself to operate in a fixed-time software configuration in order to accomplish particular processing objectives within a time frame that is supported by the current operating conditions of the mobile device. Such a fixed-time software configuration may be a trade-off between speed and quality, such that the processor executing the application may only be capable of using a certain amount of resources, a type of algorithm, or other device functionalities in order to complete a workload within its allotted time window. For example, when configured to operate with the fixed-time software configuration, the processor executing the application may be required to process digital photos at a reduced resolution in order to complete an image classification before a user is scheduled to go to work, etc.

The operations in blocks 202-206 may be similar to the operations in like numbered blocks described above with reference to FIG. 2. In block 352, the processor executing the application may identify a workload to be processed using the application. For example, the processor executing the application may evaluate a queue of files to be summarized to identify the amount of time and/or processing cycles required to process the files. In block 354, the processor executing the application may determine a goal time period for processing the identified workload. The goal time may be determined based on user preferences, such as a predetermined amount of time that the first software configuration may be used at any given time, a user input, such as a time amount entered by a user in response to a prompt from the mobile device via the application, and/or based on the obtained operating conditions of the mobile device. For example, based on available battery power, the processor executing the application may calculate an estimated amount of time for processing the workload at one or more processing qualities, processing speeds, and/or using various device resources or functionalities (e.g., codecs, transceivers, peripheral devices, etc.). In some embodiments, the processor executing the application may determine an optimized goal time and processing quality based on the identified workload. For example, the processor executing the application may determine a balance between the time to complete processing of the data and utilizing an adequate processing quality. In block 356, the processor executing the application may set a processing quality based on the obtained goal time. For example, the processor executing the application may set a computing frequency and/or may activate a particular processing routine or algorithm that may be used to process the workload within the obtained goal time.

In some embodiments, when the workload includes processing images, the processor executing the application may calculate an image resolution for processing the various images (i.e., data objects) based on a given time. For example, the processor executing the application may calculate an available processing time for each image in the workload with the following:

Ti=((total given time)−(resizing overhead))/N,

wherein Ti is the processing time for an individual image, the resizing overhead is a known or constant amount of time required by the processor executing the application for performing a one-time resizing operation, and N is the total number of images to be processed.

The available processing time for each image may then be used to determine the image resolution that may be possible using the following equation:

Image resolution=ƒ(Ti),

wherein ƒ( ) is a function taking time amounts (i.e., Ti) as inputs to output a corresponding image resolution value. Such a function may be illustrated with the graph in FIG. 3C described below.

The operations in determination block 302 may be similar to the operations in like numbered blocks described above. In response to determining that there are no more data objects to process via the application configured with the first software configuration (i.e., determination block 302=“No”), the processor executing the application may end the method 350. However, in response to determining that there are more data objects to process via the application configured with the first software configuration (i.e., determination block 302=“Yes”), the processor executing the application may determine whether the goal time is reached in determination block 358. For example, based on unforeseen resource use, such as by other applications on the mobile device, the processor executing the application may not have been able to process the workload with the first software configuration as expected. Therefore, the processor executing the application may be required to end the processing of the data objects using the application configured with the first software configuration when the obtained goal time has elapsed. In response to determining that the obtained goal time has been reached (i.e., determination block 358=“Yes”), the processor executing the application may end the method 350. However, in response to determining that the obtained goal time has not been reached (i.e., determination block 358=“No”), the processor executing the application may perform the operations for processing the next data object using the application in block 314 as described above with reference to FIG. 3A. The processor executing the application may then continue with the operations in determination block 302.

FIG. 3C illustrates an exemplary graph 370 of values of a function (referred to as ƒ(t) in FIG. 3C) plotting time against a processing quality that may be utilized by a processor executing an application configured with a fixed-time software configuration, such as described above in FIG. 3B. In particular, the graph 370 indicates a relationship wherein the processing quality of the processor executing the application may increase with the amount of time allotted to processing a certain workload, such as summarizing a set of media files (e.g., photos, videos, audio samples, etc.). For example, when the processor executing the application may perform a workload within a first time 372 (e.g., a small period of time, seconds, minutes, etc.), the processing quality may be a first level 374 (e.g., a low quality processing). However, when the processor executing the application may perform the same workload within a second time 376 (e.g., a larger period of time, seconds, minutes, etc.), the processing quality may be a second level 378 (e.g., a higher quality processing). As described above, the time that the processor executing the application may use, and thus the processing quality, may be dependent upon various factors, such as remaining battery power and/or other contextual operating conditions (e.g., time before next scheduled task/workload, etc.).

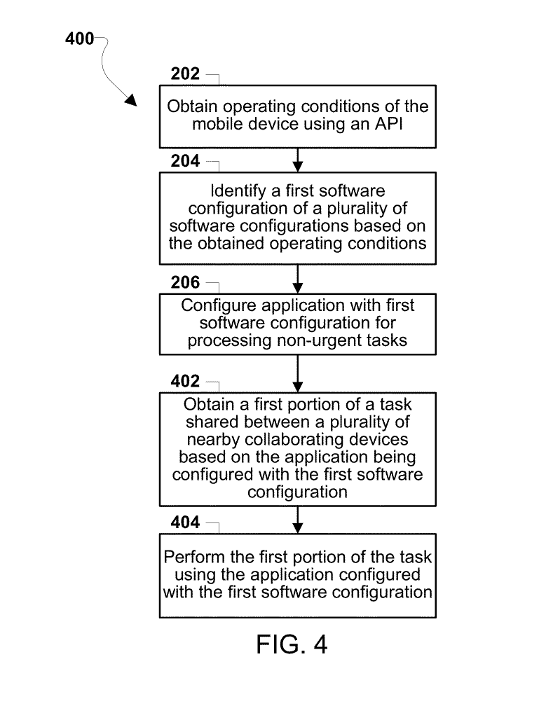

FIG. 4 illustrates an embodiment method 400 for a mobile device processor executing an application configured with a software configuration to process a portion of a task shared between a plurality of nearby collaborating devices. The method 400 may be similar to the method 200 described above, except that the method 400 may include operations for the processor executing the application to participate in a task with a workload divided between the various applications executing on the nearby collaborating devices. In particular, the processor executing the application may perform operations for completing a portion of the shared task that is allocated to the processor executing the application based at least on the software configuration of the application. For example, a master device may instruct a first processor executing a first application on a first mobile device to perform operations to process a first, large set of data when the first application is configured with a high-performance software configuration suitable for the large data set and a second processor executing a second application on a second mobile device to process a second, small set of data when the second application is configured with an economic software configuration suitable for only a small data set. In this way, the processor executing the application may be configured to contribute to shared workloads in a manner appropriate for the operating conditions of the mobile device.

The operations in blocks 202-206 may be similar to the operations in like numbered blocks described above with reference to FIG. 2. In block 402, the processor executing the application may obtain a first portion of a task shared between a plurality of nearby collaborating devices based on the application being configured with the first software configuration. For example, via a peer-to-peer connection (e.g., via a short-range wireless connection, via a Wi-Fi LAN, etc.), the processor executing the application may receive a selection of data objects to be analyzed. The first portion of the task may be indicated by instructions, code, scripts, commands, and/or other information transmitted to the mobile device by a master device. For example, a controlling member of the plurality of nearby collaborating devices may determine how to divide the workload of the shared task as described below, and may transmit messages to the various nearby collaborating devices, including the mobile device, that indicate which portions of the workload are assigned to each nearby collaborating device. In some embodiments, the mobile device itself may be the master device for the shared task, and thus may generate instructions for dividing the portions of the shared task to the plurality of nearby collaborating devices, including itself. For example, the processor executing the application may obtain the first portion of the shared task based on its own identification of the division of workload between the various nearby collaborating devices based on their individual software configurations.

In some embodiments, the first portion of the task may include processing data that is locally stored on the mobile device and/or data that is received from another device. For example, the processor executing the application may be assigned to process a first portion of the task that includes a first set of digital photos already stored on the mobile device and a second set of digital photos transmitted by a second mobile device. In some embodiments, the processor executing the application may send a message to one or more of the plurality of nearby collaborating devices requesting the first portion of the shared task. For example, the processor executing the application may cause a message to be transmitted (e.g., broadcast) via short-range wireless signals that indicates the processor executing the application is ready to receive subsequent transmissions that include data to be processed corresponding to the first portion of the shared task.

In block 404, the processor executing the application may perform the first portion of the task using the application configured with the first software configuration. For example, when configured with an economic software configuration as described above, the processor executing the application may process the first portion when the battery power and/or device temperature of the mobile device are within the predefined thresholds defined by the first software configuration. As another example, the processor executing the application may process the first portion as fast as possible when the first software configuration is a high-performance software configuration or alternatively may process the first portion within a certain time period when the software configuration defines a fixed-time.

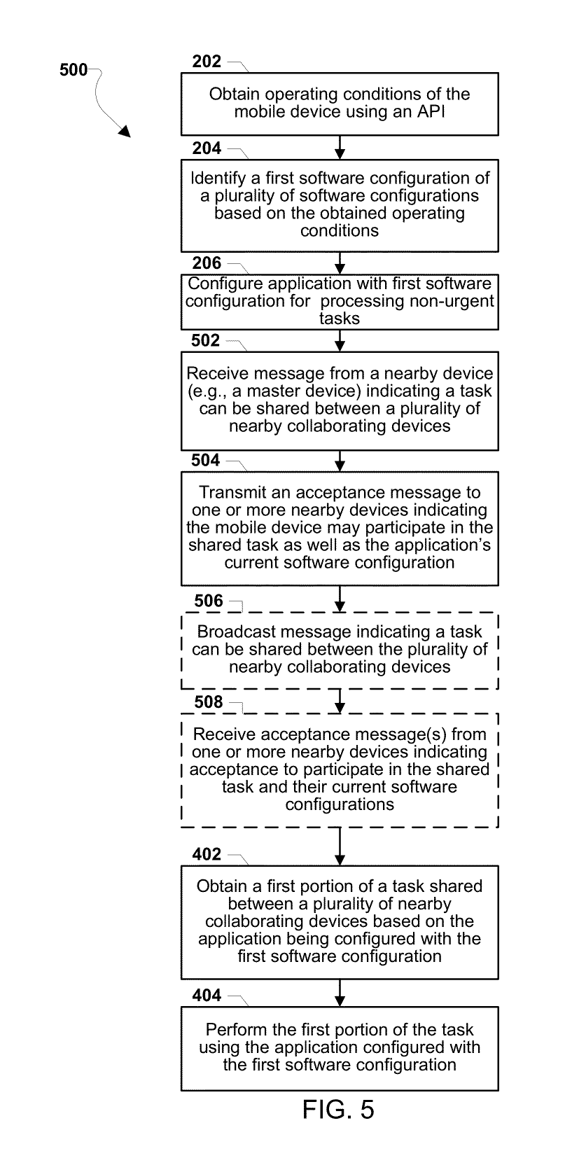

FIG. 5 illustrates an embodiment method 500 for an application executing on a mobile device to exchange messages with nearby devices when participating in a task shared between a plurality of nearby collaborating devices. The method 500 is similar to the method 400 described above, except the method 500 includes additional operations for the processor executing the application to receive various messages from nearby collaborating devices related to the shared task, such as messages indicating current software configurations of applications. For example, the processor executing the application may exchange messages with nearby collaborating devices that may include a master device configured to control (or manage) the processing of a photo summarization task.

The operations in blocks 202-206 may be similar to the operations in like numbered blocks described above with reference to FIG. 2. As described above, by default, the processor executing the application configured with its software configuration may be configured to perform operations and process data stored locally on the mobile device. For example, the application may simply be executed by the mobile device to summarize digital media files stored in a local media library or media folder. However, the processor executing the application may also be configured to monitor for messages that indicate the presence of tasks that may be shared between nearby collaborating devices, and in response to receiving such messages, may perform operations for contributing to the shared tasks when appropriate. Accordingly, in block 502, the processor executing the application may receive a message from a nearby device (e.g., a master device, a non-master mobile device, etc.) indicating a task is available that can be shared between a plurality of nearby collaborating devices. For example, the processor executing the application may receive the message indicating a photo summarization task is available to all nearby devices executing a certain common application capable of causing devices to perform photo summarization. The message indicating the task may include requirements information for participating in the shared tasks, such as a software configuration the application must be configured with in order to participate in the shared task. For example, the message may include instructions for the processor executing the application to configure the application with a high performance software configuration. As another example, the message may indicate the shared task may require a certain amount of time or battery power to complete. In some embodiments, the processor executing the application may configure the application with a second software configuration in response to receiving the message from the nearby device. For example, the message may include instructions that may cause the processor executing the application to deactivate a current high performance software configuration of the application and activate a fixed-time software configuration in order for the processor executing the application to process data over a certain period of time, or vice versa.

In block 504, the processor executing the application may transmit an acceptance message to one or more nearby devices indicating the mobile device may participate in the shared task. In particular, the acceptance message may be transmitted for receipt by a designed master device associated with the shared task. The acceptance message may also include the software configuration that the application is currently configured with (i.e., the first software configuration). For example, the acceptance message may include a code or other information that represents the availability (or willingness) of the processor executing the application to participate in the shared task, as well as data (e.g., metadata) indicating the operating conditions of the mobile device (e.g., battery power, scheduled routines, etc.), the possible software configurations available to the application, and the software configuration with which the application is currently configured to operate. The information within the acceptance message may be used by recipient devices (e.g., a master device) to distribute additional data related to the shared task, such as individual instructions for the processor executing the application and data sets to be processed by the processor executing the application. For example, a master device receiving the acceptance message may determine that the processor executing the application may process a large amount of data of the shared task based on the application being configured with a high-performance software configuration, its large amount of battery power, its processor capabilities, and/or its high bandwidth communication protocol.

In some embodiments, the acceptance message may be broadcast to all nearby devices or alternatively may be transmitted to a particular recipient device or recipient address (e.g., media access control (MAC) address, IP address, etc.) as indicated in the message received with the operations in block 502. Further the acceptance message may be transmitted using a communication protocol and/or format indicated in the message received with the operations in block 502.

In some embodiments, the mobile device may be designated to operate as a master device with regard to controlling and distributing shared tasks to nearby collaborating devices. Accordingly, in optional block 506, the processor executing the application may broadcast (or otherwise transmit) a message indicating a task can be shared between the plurality of nearby collaborating devices. Such a message may be similar to the message described above with reference to block 502. Further, in optional block 508, the processor executing the application may receive acceptance message(s) indicating acceptance of one or more nearby devices to participate in the shared task broadcast (or otherwise transmitted) by the mobile device, as well as current software configurations of the one or more nearby collaborating devices. When the mobile device is configured to function as a master device for a given shared task, the processor executing the application may use information from such received acceptance messages to determine how to divide a workload of the shared task broadcast (or otherwise transmitted) by the application. For example, based on the software configurations reported in the received acceptance messages, the processor executing the application may determine the various data sets for each of the responding nearby collaborating devices to process as part of the shared task. The received acceptance messages may be similar to the acceptance message described above with reference to block 504. The processor executing the application may continue with the operations in blocks 402-404 as described above with reference to FIG. 4.

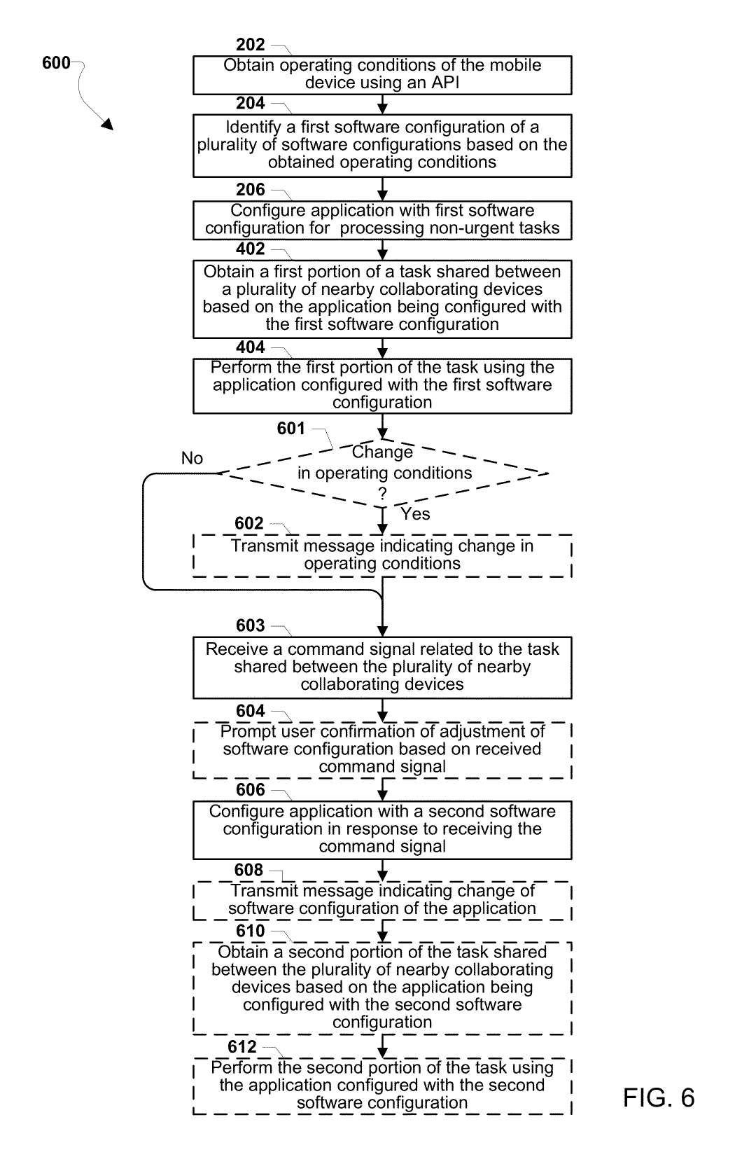

FIG. 6 illustrates an embodiment method 600 for a mobile device processor executing an application to receive a command signal for adjusting software configurations when processing portions of a task shared between a plurality of nearby collaborating devices. The method 600 is similar to the method 400 described above, except the method 600 includes additional operations for the processor executing the application to change the software configuration of the application based on instructions from a nearby device, such as a master device configured to control the processing of the shared task. For example, in response to receiving a command, the processor executing the application may switch the application from a high-performance software configuration to an economic software configuration in order to accommodate a diminished battery in the mobile device.

The operations in blocks 202-206 and 402-404 may be similar to the operations in like numbered blocks described above with reference to FIG. 2 and FIG. 4, respectively.

In optional determination block 601, the processor executing the application may determine whether there is a change in the operating conditions of the mobile device, such as in response to conducting periodic or continuous polling operations as described above. For example, the mobile device processor via the application may obtain current GPS coordinates, available battery power, device temperature, etc. and compare it to previously obtained data to identify changes in values that exceed predefined threshold values (e.g., battery threshold, etc.). In response to determining that there is a change in operating conditions (i.e., optional determination block 601=“Yes”), the processor executing the application may transmit a message indicating the change in operating conditions. Such a message may be broadcast or directed transmission receivable by a master device organizing a shared workload and that may trigger the master device to reconfigure the participation of the mobile device and/or other collaborating devices as well as redistribute tasks based on the reconfigured participations. For example, based on the message indicating the battery of the mobile device is now fully charged, the master device may increase the workload assigned to the mobile device.

In response to determining that there is a change in operating conditions (i.e., optional determination block 601=“No”), or in response to the mobile device processor performing the operations in optional block 602, the processor executing the application may receive a command signal (or message) related to the task shared between the plurality of nearby collaborating devices in block 603. The command signal may be sent from a master device (e.g., via an application executing on a master device) that controls the shared task, and may include a code, script, instructions, and/or other information that the processor executing the application may process or otherwise execute. For example, the command signal may be a wireless signal reporting a bit or code instructing the processor executing the application to perform an action, such as a suspend operation or an execute operation. In some embodiments, the command signal may include instructions that cause the processor to configure the application with a certain software configuration. In other words, the command signal may instruct a change of an active software configuration based on the operating conditions of the mobile device. For example, the command signal may cause the processor executing the application to deactivate a current software configuration (e.g., an economic software configuration) and activate a high-performance software configuration. In some embodiments, the command signal may include parameter values for an already configured software configuration of the application, such as new threshold values to be used with an already activated economic software configuration. For example, the command signal may include a new device temperature threshold value that may indicate when the processor executing the application configured with an economic software configuration may suspend operations related to the shared task.

In various embodiments, the command signal may be received before or after the processor executing the application begins to process any portion of the shared task. For example, the command signal may be received prior to the processor executing the application has begun to process digital media files in a collaborative summarization task, causing the processor executing the application to change the application from an economic software configuration to a high-performance software configuration prior to processing the first portion of the shared task. As another example, the command signal may be received by the processor executing the application in response to completing the processing of a first portion of the shared task, causing the processor executing the application to configure the application with a different software configuration so that the processor may be configured to perform additional portions of the shared task.

In some embodiments, the command signal may be sent to cause the processor executing the application to re-configure the application in order to match the software configuration of applications running on the nearby collaborating devices. For example, when executing a shared task, each application on each nearby collaborating device may be required to be configured with the same software configuration that enables a particular communication protocol (e.g., Bluetooth, etc.) before the shared task may commence execution.

In optional block 604, the processor executing the application may prompt a user confirmation (or authorization) of an adjustment of software configuration for the application based on the received command signal. In other words, when the received command signal indicates that the application should be configured with a software configuration different from its current software configuration, the mobile device may render a message requesting the user of the mobile device to confirm such a change. For example, the processor executing the application may render a message indicating that the command signal requests the application be configured with a high-performance software configuration like other devices within the nearby collaborating devices. Such prompting may include providing the user with graphical user interface buttons for providing user inputs that select to confirm or reject the change of software configurations based on the received command signal. In some embodiments, the prompting may include presenting information indicating the effects of changing the software configuration of the application, such as reduced user experience and/or increases in device resource use (e.g., increased battery power use, increased device component heat, deactivation/activation of device components such as transceivers, etc.). For example, the mobile device may render a warning (e.g., a pop-up box) to information the user of the mobile device that executing the application configured with the second software configuration may be more expensive than executing the application with the first software configuration. In some embodiments, user inputs may not be required to confirm or authorize the change of software configuration for the application, and instead an automated, context-aware engine (e.g., a routine, service, etc.) may evaluate the command signal to determine whether the application may be re-configured with a software configuration different from its current or default software configuration.

In block 606, the processor executing the application may configure the application to operate with a second software configuration in response to receiving the command signal, such as by setting various operating parameters (e.g., thresholds, processing quality, processing speed, etc.) based on stored data of the second software configuration. In other words, the processor executing the application may deactivate the first software configuration and may activate the second software configuration. The operations of block 606 may be similar to those described above with reference to block 206. In some embodiments, switching software configurations may cause the processor executing the application to utilize different communication protocols and/or transceivers for processing the shared task. For example, when a more efficient communication protocol is identified by the master device orchestrating the various nearby collaborating devices regarding the shared task, the command signal may include instructions for the processor to cause the application to enter a software configuration that is associated with that efficient communication protocol. In this way, the processor executing the application may be adjusted to better operate in combination with the other nearby collaborating devices.

In optional block 608, the processor executing the application may transmit a message indicating the change of software configuration of the application. For example, in order to inform the configuration change of the application, the mobile device may transmit update messages to each of the nearby collaborating devices. In some embodiments, the processor executing the application may pause or continue processing of the first and/or second portion of the shared task, initiate the processing of the portions of the task, and/or put the portions of the shared task on a waiting list to be performed at a subsequent time.

In optional block 610, the processor executing the application may obtain a second portion of the task shared between the plurality of nearby collaborating devices based on the application being configured to operate with the second software configuration. For example, the command signal may have been sent by a master device in response to the processor executing the application completing the processing of the first portion of the data using the application configured with the first software configuration, and thus the processor executing the application may be directed to gather a new data set for processing. The second portion of the shared task may be larger (e.g., more files to summarize, etc.), smaller, more complex (e.g., larger media files to summarize, etc.), and/or more simplified than the first portion of the shared task. Further, the second portion may be particularly well-suited for processing by the processor executing the application configured with the second software configuration. For example, the processor executing the application may obtain a new portion of the shared task that includes time-sensitive data that may be appropriately processed using the application configured with a fixed-time software configuration.

Similar to the operations in block 404, in optional block 612, the processor executing the application may perform the second portion of the task using the application configured with the second software configuration. For example, the processor executing the application may perform media summarization operations with a high-performance software configuration on a second set of digital photos.

In some embodiments, the processor executing the application may only begin to process any portion of the data of the shared task in response to receiving the command signal and configuring the application to operate with the second software configuration. In other words, the shared task may only be started by the processor executing the application when the application has been configured according to the master device with regard to the shared task.

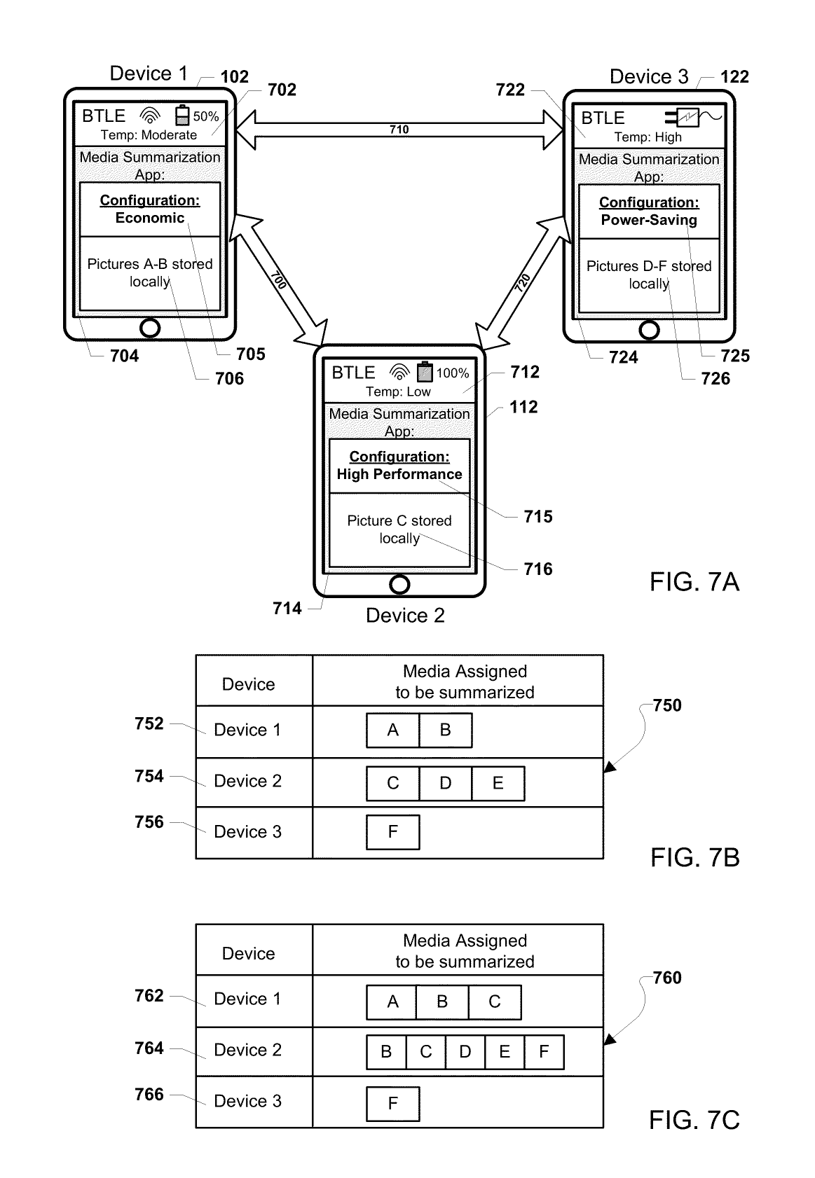

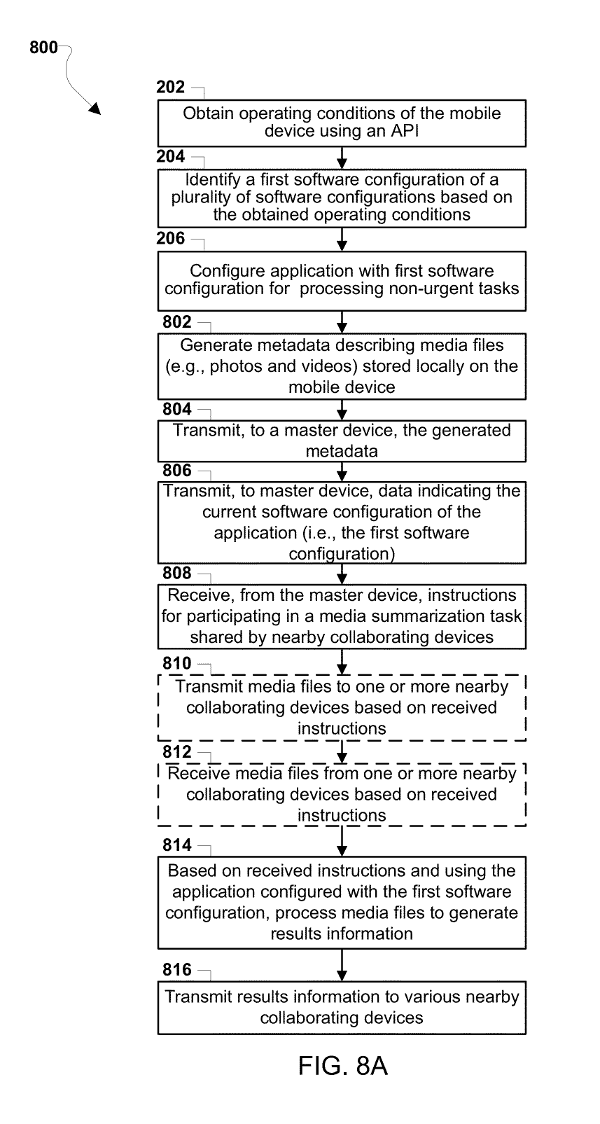

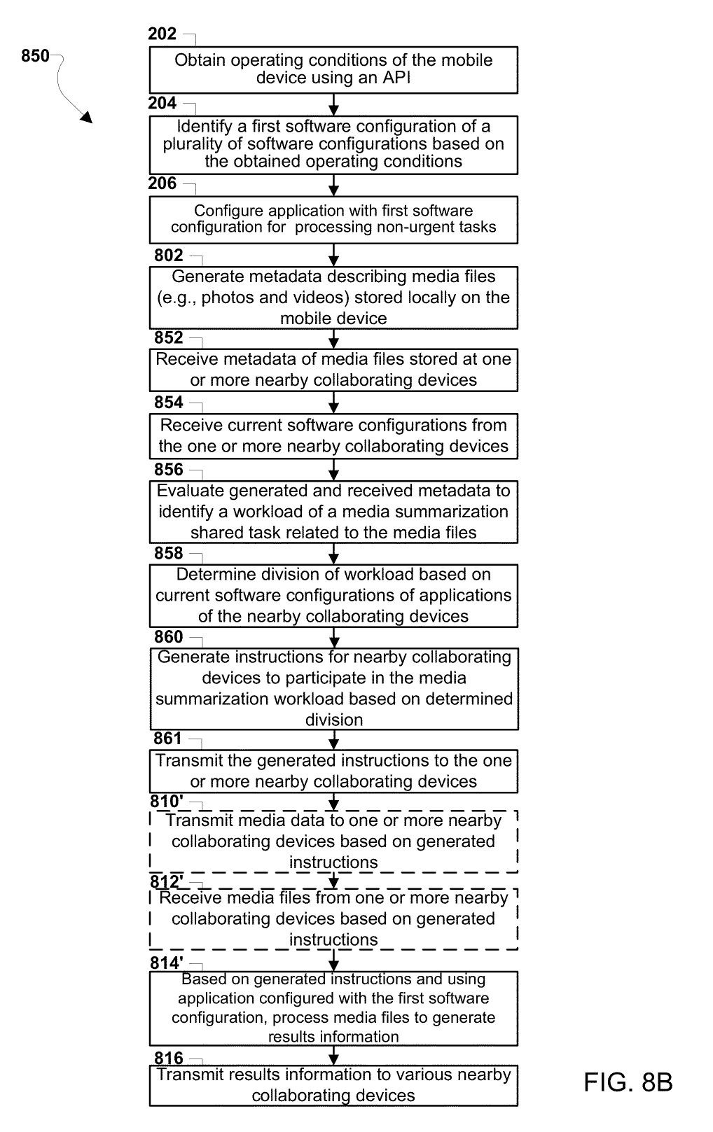

FIGS. 7A-C, FIGS. 8A-8B relate to a particular application of embodiment software configurations in a collaborative computing environment for processing media stored on various nearby mobile devices. For example, during a daytime trip to an amusement park, each member of a family may carry their own smartphone for taking digital media of their individual experiences. A mom may take photos of a roller coaster with a first smartphone, a son may take a video of a concession stand with a second smartphone, and a dad may take photos of a mascot standing in a parking lot with a third smartphone. The smartphones used by the various family members may be configured with software for summarizing media files (i.e., summarization applications), but may not have an adequate means (e.g., a good data plane) for sharing digital media files during the daytime at the amusement park. Accordingly, the media files taken by each family member may reside exclusively on their individual smartphones without being shared for use with the summarization applications executing on the various devices.

However, at night after leaving the amusement park, the family may congregate in a same hotel room. Each of the smartphones may be placed within proximity on the same table, such as for charging or merely to keep them in a safe location. With an adequate environment for peer-to-peer sharing on the table, such as via WiFi or short-range signaling (e.g., Bluetooth, etc.), the smartphones may determine that the various media files may be collaboratively processed by the summarization applications executing on each of the smartphones. As each of the smartphones may have different operating conditions (e.g., active transceivers, battery power, processor types, scheduled routines, etc.), their individual summarization applications may each be configured with different software configurations. For example, a first summarization application on the first smartphone may be configured with an “economic” software configuration, a second summarization application on the second smartphone may be configured with an “high-performance” software configuration, and a third summarization application on the third smartphone may be configured with an “fixed-time” software configuration. The smartphones may communicate with each other via their respective summarization applications, and may exchange media files (e.g., photos, etc.) so that all the media taken by the various mobile devices during the day at the amusement park are consolidated, organized, and have a short summary. Each of the summarization applications executing on the various smartphones may contribute different amounts of work to the summarization of the entire group of media files based on its individual software configuration. In this way, each of the smartphones (and their users) may benefit from a complete summarization of the media files, however the workload for each smartphone may only be what that individual device may handle based on its current operating conditions.

FIG. 7A illustrates an exemplary scenario in which a plurality of mobile devices 102, 112, 122 may be configured to utilize applications configured with various software configurations in order to collaboratively perform a shared task (e.g., media summarization). A first mobile device 102 (referred to in FIGS. 7A-C as “Device 1”) may include a first display 702 of some of its operating conditions, such as available transceivers (e.g., Bluetooth Low Energy or “BTLE”, WiFi), available battery power (e.g., 50%), and a device temperature (e.g., “moderate”). The first mobile device 102 may execute a first application 704 (e.g., a media summarization app) that is configured with a first software configuration 705 (referred to as an “economic”). As described above, such an economic software configuration may be automatically configured based on the operating conditions of the first mobile device 102 as described above. For example, the first application 704 may be configured with the economic software configuration based on a moderate device temperature reading along with a half-depleted battery. The first application 704 may also be associated with a first set of media files 706 (e.g., pictures A-B) that are stored locally on the first mobile device 102.

A second mobile device 112 (referred to in FIGS. 7A-C as “Device 2”) may include a second display 712 of some of its operating conditions, such as available transceivers (e.g., BTLE, WiFi), available battery power (e.g., 100%), and a device temperature (e.g., “low”). The second mobile device 112 may execute a second application 714 (e.g., the media summarization app) that is configured with a second software configuration 715 (referred to as “high-performance”). The second software configuration 715 may be automatically configured based on the operating conditions of the second mobile device 112 as described above. For example, the second application 714 may be configured with the high-performance software configuration based on a low device temperature reading and/or a full battery. The second application 714 may also be associated with a second set of media files 716 (e.g., picture C) that are stored locally on the second mobile device 112.

A third mobile device 122 (referred to in FIGS. 7A-C as “Device 3”) may include a third display 722 of some of its operating conditions, such as an available transceiver (e.g., BTLE), a power reading (e.g., plugged into power source), and a device temperature (e.g., “High”). The third mobile device 122 may execute a third application 724 (e.g., the media summarization app) that is configured with a third software configuration 725 (referred to as “power-saving”). The third software configuration 725 may be automatically configured based on the operating conditions of the third mobile device 122 as described above. For example, the third application 724 may be configured with the power-saving software configuration based on being plugged into the power source and/or having a high device temperature reading. The third application 724 may also be associated with a third set of media files 726 (e.g., pictures D-F) that are stored locally on the third mobile device 122. In some embodiments, the various software configurations may be set in the mobile devices 102, 112, 122 based on user inputs as described below.

The mobile devices 102, 112, 122 may exchange transmissions via wireless connections 700, 710, 720. For example, the first mobile device 102 and the second mobile device 112 may exchange Bluetooth packets via the first wireless connection 700, the first mobile device 102 and the third mobile device 122 may exchange Bluetooth packets via the second wireless connection 710, and the second mobile device 112 and the third mobile device 122 may exchange Bluetooth packets via the third wireless connection 720. In various embodiments, the mobile devices 102, 112, 122 may utilize other connections for peer-to-peer communications, such as via communications via a router associated with a local area network as described above with reference to FIG. 1.

The exchanged transmissions may include various messages, such as messages indicating the current software configuration of each of the applications 704, 714, 724, as well as command signals and/or other instructional messages that may indicate how the workload of a shared task may be divided between the mobile devices 102, 112, 122. The transmissions via the wireless connections 700, 710, 720 may also include data to be processed via the applications 704, 714, 724. In particular, based on instructions from a “master” device configured to organize the operations of the mobile devices 102, 112, 122 with regard to the shared task based on their respective software configurations 705, 715, 725, the mobile devices 102, 112, 122 may deliver various media files to one another for processing. For example, based on instruction messages, the first application 704 may cause a media file (e.g., picture B) to be sent to the second mobile device 112 or the third mobile device 122 for processing by their respective applications 714, 724 (and processors).

In various embodiments, the master device may be any one of the mobile devices 102, 112, 122. Alternatively, the master device may be determined based on a current software configuration or operating conditions, such as the mobile device having the highest available power (or battery power), the least burdened processor, the most locally stored data, the best networking conditions (e.g., high bandwidth, etc.), and/or a user input selecting the master device.

FIGS. 7B-7C show tables 750, 760 that illustrate exemplary divisions of a workload of a task shared between nearby collaborating devices. As described above, each mobile device participating in the shared task may be assigned or otherwise instructed to perform a portion of the shared task based on their respective applications' software configurations, such as configurations automatically set by their processors executing their applications based on the operating conditions of the mobile devices. The tables 750, 760 illustrate how the media files that are locally stored on the mobile devices 102, 112, 122 may be divided for summarization by processors executing the applications 704, 714, 724 based on their software configurations 705, 715, 725. In various embodiments, such divisions of the workload may be identified and communicated by a master device as described above.

The table 750 in FIG. 7B illustrates a division of the shared media summarization task wherein the various media files stored on the mobile devices 102, 112, 122 may be processed by at most one device executing one of the applications 704, 714, 724. The table 750 includes a first row 752 associated with the first mobile device 102 illustrated in FIG. 7A. Based on its first software configuration 705, the first application 704 of the first mobile device 102 may be assigned two media files (e.g., pictures A and B). As described above with reference to FIG. 7A, the first mobile device 102 may also store the assigned media files, and so may not need to utilize the wireless connections 700, 710 to receive the media files. A second row 754 indicates that, based on the second software configuration 715, the second application 714 executing on the second mobile device 112 may be assigned three media files (e.g., pictures C-E). As the second mobile device 112 may only locally store one of these three media files (e.g., only picture C is locally stored), the second mobile device 112 via the second application 714 may need to request the other assigned media files from the other mobile devices 102, 122 collaborating on the shared media summarization task. For example, the second mobile device 112 via the second application 714 may transmit a message to the third mobile device 122 requesting the delivery of the pictures D-E. The second application 714 may be assigned a larger number of media files to process than the first application 704 (or the third application 724), as the second application 714 is configured with the high-performance software configuration and thus, when executed by the processor of the second mobile device 112, may be capable of handling more workload without risking degraded performance. A third row 756 indicates that, based on the third software configuration 725, the third application 724 executing on the third mobile device 122 may be assigned one media file (e.g., picture F). As the third mobile device 122 stores more than its assigned media file (e.g., pictures D-F), the third application 724 executing on the third mobile device 122 may receive requests to deliver the unassigned media files (e.g., pictures D-E) from another application that is assigned those media files (e.g., the second application 714).

The table 760 in FIG. 7C is similar to the table 750 in FIG. 7B, except that the various media files stored on the mobile devices 102, 112, 122 may be assigned for processing by one or more of the mobile devices 102, 112, 122 via their respective applications 704, 714, 724. In this way, the workload of the shared task may be distributed in an overlapping manner. Such a scheme may balance performance variances by the mobile devices 102, 112, 122, thereby minimizing potential impacts to efficiency of the shared task caused by unexpected changes in the speed and/or quality of processing using the applications 704, 714, 724. Thus, a first row 762 may indicate that the first application 704 may be assigned three media files (e.g., pictures A-C) based on its first software configuration 705, a second row 764 may indicate that the second application 714 may be assigned five media files (e.g., pictures B-F) based on its second software configuration 715, and a third row 766 may indicate that the third application 724 may be assigned one media file (e.g., picture F) based on its third software configuration 725. Based on its first software configuration 705, the first mobile device 102 executing the first application 704 may be capable of processing one additional file (e.g., picture C) overlapping with the assigned media files of the second application 714 without being assigned fewer media files than in the division shown in FIG. 7B. Such an additional file may be received from the second application 714 via a transmission between the first mobile device 102 and the second mobile device 112 as described above. Further, as the second application 714 is configured with a high-performance software configuration (i.e., the second 715), it may be assigned multiple media files (e.g., pictures B and F) overlapping with the first application 704 and the third application 724. The second mobile device 112 executing the second application 714 may receive various files from the first and third mobile device 102, 122 via transmissions as described above. Based on its power-savings software configuration, the third application 724 may not be assigned any additional media files.

FIGS. 8A-B illustrate embodiment methods 800, 850 for a mobile device processor executing an application to perform a portion of a task of summarizing media shared between a plurality of nearby collaborating devices. The methods 800, 850 may be similar to the methods described above, but may include operations specific to a use case of summarizing media stored on various devices within proximity of one another.

FIG. 8A illustrates an embodiment method 800 for such a media summarization shared task. The operations in blocks 202-206 may be similar to the operations in like numbered blocks described above with reference to FIG. 2. In block 802, the processor executing the application may generate (or collect) metadata of media files stored locally on the mobile device. For example, the processor executing the application may generate metadata indicating the number, file size, runtime, type, timestamps, geo-location data, and other information of various media files, such as digital photos and videos. In block 804, the processor executing the application may transmit, to a master device, the generated metadata. In block 806, the processor executing the application may transmit to the master device data indicating the current software configuration of the application (i.e., the first software configuration). In some embodiments, the processor executing the application may transmit information indicating some or all of the obtained operating conditions as well as the current software configuration of the application. For example, the processor executing the application may transmit to the master device data that indicates the current battery power of the mobile device.

In some embodiments, the processor executing the application may cause the mobile device to broadcast (or otherwise transmit) the information transmitted in the blocks 804-806 so that an undisclosed or not already identified master device within proximity of the mobile device may receive the data. For example, the processor executing the application may periodically cause the mobile device to broadcast useful data that may or may not be used by nearby collaborating devices to initiate a shared task. In other embodiments, the master device may be predetermined.

In block 808, the processor executing the application may receive from the master device instructions for participating in a media summarization task shared by nearby collaborating devices. Such instructions may include commands, codes, scripts, and/or other information that indicate how the processor executing the application may distribute and process media files as part of the media summarization task. For example, the instructions may include the identifiers of a set of digital photograph files (e.g., jpegs, gifs, bitmaps, etc.) the processor executing the application should analyze for content, authorship, represented persons, places, and/or things. In some embodiments, the instructions may indicate the algorithms, such as facial recognition processing techniques, modules, and/or filtering that may be used by the processor executing the application to process the media files.

In some embodiments, the instructions may also include information for the processor executing the application to distribute locally stored media files (or data related to the media files) to other nearby collaborating devices for processing. For example, the instructions may include the identifiers of a set of photo or video files that may be transmitted via a WiFi connection to another mobile device also participating in the media summarization shared task. The instructions may therefore also include the device identifier, network address, and/or communication protocol for the processor executing the application to transfer the media files to the other mobile device(s).

In some embodiments, the instructions may also include information indicating media files that are to be received at the processor executing the application from other nearby collaborating device(s). For example, the instructions may indicate a number or range of digital photographs that are to be transmitted by a certain nearby smartphone using a particular communication protocol (e.g., Bluetooth).

In some embodiments, the instructions may also include commands that may cause the processor to configure the application with a different (or second) software configuration, such as a software configuration shared by the other nearby collaborating devices or another software configuration deemed appropriate by the master device in view of the software configurations of the other nearby collaborating devices. For example, only a certain percentage of the applications executing on the nearby collaborating devices may need to be configured with a high performance software configuration, and so the processor executing the application may receive instructions to configure the application to use a less expensive software configuration.

In optional block 810, the processor executing the application may transmit media files to one or more nearby collaborating devices based on the received instructions for distributing the media files. For example, the processor executing the application may cause a set of locally stored video files to be transmitted over a local area network connection to a nearby smartphone for further processing. In some embodiments, the media files themselves may not be transmitted, but instead the processor executing the application may transmit metadata related to the media files.

In optional block 812, the processor executing the application may receive media files from one or more nearby collaborating devices based on the received instructions. For example, due to the application's current software configuration, the processor executing the application may be capable of processing more media files than other nearby collaborating devices, and so may receive media files via a Bluetooth connection.

In block 814, based on the received instructions and using the application configured with the first software configuration, the processor executing the application may process the received media files to generate results information. The results information may be order/sorting results, identified items within the media files (e.g., known persons, places, and/or things), and/or statistical or analytics information about the media files and/or the processing of the media files. For example, the results information may indicate the amount of time that the processor executing the application performed analysis routines for each photo within the media files. In some embodiments, the results information may be a sorted listing of the media files or the media files themselves with additional or adjusted data (e.g., added tags, annotations, renamed filenames, etc.).

In block 816, the processor executing the application may transmit the results information to various nearby collaborating devices, such as the master device. For example, the processor executing the application may transmit results information related to the media files received with the operations in optional block 812 to the nearby collaborating device that initially transmitted those media files to the mobile device.

FIG. 8B illustrates an embodiment method 850 for a mobile device processor executing an application to perform a portion of a task of summarizing media shared between a plurality of nearby collaborating devices. The method 850 is similar to the method 800 described above, except the method 850 may be performed by a mobile device designated as a “master” device configured to control the division of the workload associated with the shared media summarization task. For example, the processor executing the application may perform operations that include sending messages to nearby collaborating devices that direct the subsequent operations of those nearby collaborating devices with regard to the shared task of summarizing media files.

The operations in blocks 202-206 and 802 may be similar to the operations in like numbered blocks described above with reference to FIG. 2 and FIG. 8A, respectively. In block 852, the processor executing the application may receive metadata of media located at one or more nearby collaborating devices. For example, the processor executing the application may receive messages from each device participating in the shared task that indicate the number and type of media files that may be summarized via the applications executing on the devices.

In block 854, the processor executing the application may receive current software configurations from the one or more nearby collaborating devices. For example, the processor executing the application may receive messages from each of the nearby collaborating devices indicating whether they are operating with an economic, high-performance, power-saving, and/or other software configuration. In some embodiments, the processor executing the application may also identify operating conditions of the various devices from received messages, such as current battery power, networking conditions, etc.

In block 856, the processor executing the application may evaluate the received metadata to identify a workload for a task related to the media files that may be shared amongst the one or more nearby collaborating devices (e.g., a summarization task). In other words, the processor executing the application may evaluate information received from the various nearby collaborating devices to determine how many total media files need to be summarized by applications executing on the nearby collaborating devices. The processor executing the application may also determine the types of processing, such as sorting, facial recognition, etc., that may be required to process the various media files related to the summarization task.

In block 858, the processor executing the application may determine a division of the workload based on the current software configurations of the applications executing on the nearby collaborating devices. For example, the processor executing the application may evaluate the resources and capabilities of the various nearby collaborating devices to determine how to best assign media files to the individual devices. As another example, the processor executing the application may determine how many media files each nearby collaborating device may be assigned in order to complete the summarization task within a certain time period. The processor executing the application may utilize various different objectives and goals when determining the division of the workload, such as maximizing the speed at which the task is completed, minimizing the amount of battery power utilized by the devices in completing the task, and minimizing the amount of file transfers required to complete the task. In some embodiments, the processor executing the application may divide the workload such that nearby collaborating devices with applications configured with high-performance software configurations and/or high amounts of available power may be assigned more media files to process.

In block 860, the processor executing the application may generate instructions for distributing the workload based on determined division. As described above, the generated instructions may indicate information that may cause the various nearby collaborating devices participating in the shared task to perform various operations, such as transmitting media files to one another and/or performing processing operations on various media files that may or may not be originally stored on the various devices. In some embodiments, the instructions may also include commands that cause the nearby collaborating devices to adjust or change the current software configurations of their applications, such as commands for adjusting thresholds of software configurations or for directing another application to activate a different software configuration entirely.

In block 861, the processor executing the application may transmit the generated instructions to the one or more nearby collaborating devices. For example, the processor executing the application may cause the mobile device to transmit the instructions to each of the nearby devices that are eligible to participate in the shared task of summarizing the media files. In various embodiments, the processor executing the application may transmit different instructions for each individual nearby device. For example, the processor executing the application may transmit to a first nearby device a first instructions message indicating a first set of media files to be processed by the first nearby device and may transmit to a second nearby device a second instructions message indicating a second set of media files to be processed by the second nearby device.

In optional block 810′, the processor executing the application may transmit media files to one or more nearby collaborating devices based on the generated instructions. In optional block 812′, the processor executing the application may receive media files from the one or more nearby collaborating devices based on the generated instructions. In block 814′, based on the generated instructions and using the application configured with the first software configuration, the processor executing the application may process media files to generate results information. The operations in blocks 810′, 812, and 814′ may be similar to those described above with reference to blocks 810, 812, and 814, except that the processor executing the application may utilize the instructions generated locally instead of receiving the instructions from another device. The processor executing the application may then perform the operations in block 816 as described above with reference to FIG. 8A.

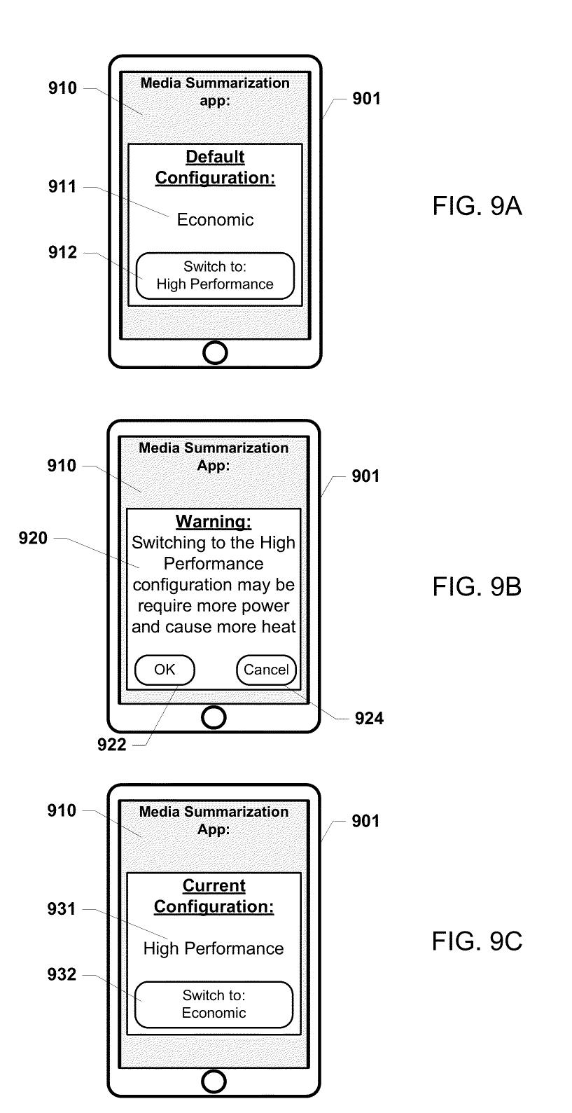

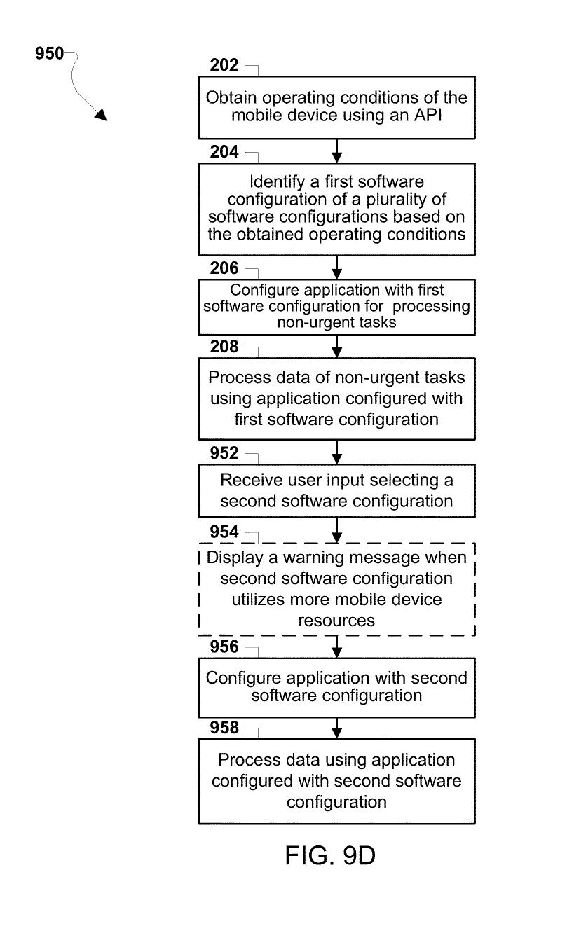

FIGS. 9A-9C illustrate embodiment interfaces that indicate and/or adjust various software configurations used by an application. The current operating conditions for a mobile device may be obtained and used by processors executing applications to automatically set a software configuration (or default software configuration), as described above. However, in some scenarios, a user may desire to manually set or change the default software configuration in order to achieve a different user experience when executing the application at a given time. For example, when an application is configured with an economic performance software configuration that causes the processor executing the application to suspend activity when the mobile device temperature exceeds a certain threshold, the user may want to configure the application with a high-performance software configuration in order to avoid any such suspensions. Such manual adjustments from default software configurations may be beneficial when the user has more information than the processor executing the application may obtain via the operating conditions of the mobile device. For example, when the user knows he is about to shut the phone off or plug it in right after a task is completed, he may not care about the current low battery power and accordingly may not want to use the economic software configuration that may suspend the task.

FIG. 9A illustrates a mobile device 901 executing an application 910 (e.g., a media summarization app). The mobile device 901 executing the application 910 may render a message 911 or other information that indicates the default software configuration of the application 910. For example, the message 911 may indicate that based on the current operating conditions of the mobile device 901, the application is configured with an economic software configuration that may cause the processor of the mobile device 901 to suspend activities of the application 910 in response to detecting low battery power, high device temperature, and/or other predefined conditions.

In some embodiments, the default software configuration may be set by the user or an application provider (or developer) as a preferred or default configuration for the application. The mobile device 901 executing the application 910 may display a graphical user interface (GUI) element 912 for adjusting the software configuration of the application 910. For example, the element 912 may be a button that, when selected (e.g., touched by the user's finger or other input device, such as a stylus, etc.), may cause the processor executing the application 910 to switch the application 910 from the default configuration of the economic software configuration to a high-performance software configuration.

FIG. 9B illustrates a warning message 920 associated with the application 910 that is rendered by the mobile device 901 in response to the user's input to configure the application 910 with a high-performance software configuration. The warning message 920 may prompt the user to confirm the adjustment of the software configuration of the application 910, and may further indicate the effects or repercussions of such a change. For example, the warning message 920 may indicate that switching from a default economic software configuration to a high-performance software configuration may cause the mobile device 901 processor executing the application 910 to require more energy and to generate more heat. The warning message 920 may indicate various other information, such as the impact on a battery, estimated effect on other applications running on the mobile device 901 (e.g., other applications may slow-down or be suspended, etc.), and effects on communications (e.g., degraded or improved quality of service via wireless transmissions, etc.).

The application 910 may include a first GUI element 922 (e.g., button) for the user to confirm the change of the software configuration and a second GUI element 924 (e.g., button) for the user to reject the change of the software configuration. For example, the user may select the first GUI element 922 (e.g., touch with his/her finger) in order to cause the mobile device 901 processor executing the application 910 to be configure the application 910 with the high-performance software configuration instead of the default economic software configuration. In some embodiments, the warning message 920 may be a pop-up box, a dialog box, modal or modeless window, or other graphical representation within the application 910.

FIG. 9C illustrates a new message 931 indicating the adjusted software configuration of the application 910 executing on the mobile device 901. For example, in response to the user confirming the switch from an economic software configuration to a high-performance software configuration as shown in FIG. 9B, the new message 931 may indicate the current configuration of the application 910 is now the high-performance software configuration. Further, the application 910 may include a GUI element 932 (e.g., button) for the user to change the current software configuration to another configuration, such as an original, default software configuration. For example, the GUI element 932 may be pressed by the user in order to cause the mobile device 901 processor to cause the application 910 to revert to the economic software configuration from the high-performance application confirmation. In some embodiments, the new message 931 may be a pop-up box, a dialog box, modal or modeless window, or other graphical representation within the application 910.

FIG. 9D illustrates an embodiment method 950 for a mobile device processor executing an application to configure the application with a second software configuration in response to user inputs. The method 950 is similar to the method 200 described above with reference to FIG. 2, except that the method 950 includes operations for receiving user inputs that may cause an application to be configured with a software configuration chosen by the user as opposed to automatically chosen by the processor executing the application. For example, instead of utilizing a default software configuration that was automatically identified as appropriate for the application based on the current battery power and device temperature of the mobile device, the user may switch the application to a high-performance software configuration in order to cause the processor executing the application to quickly process a workload, regardless of the implications to the battery and/or overall device performance.

The operations in blocks 202-208 may be similar to the operations in like numbered blocks described above with reference to FIG. 2. In block 952, the processor executing the application may receive a user input selecting a second software configuration, such as via a graphical user interface (GUI) as shown in FIG. 9A above. For example, the mobile device may detect a touch input on a touchscreen of the mobile device, the touch input corresponding to a GUI button for switching software configurations for the application. The second software configuration may be an alternative configuration to the first software configuration, and thus may or may not provide better or worse performance for the mobile device and/or the application. In some embodiments, the received user input may indicate operating parameters (e.g., thresholds) or other information relevant to a software configuration. For example, when a background or power-savings software configuration is selected via the user inputs, the user may also indicate a time of day (e.g., late at night, etc.), a power condition (e.g., plugged in), or a duration for running the application.

As described above, in some embodiments, regardless of user inputs selecting software configurations, the processor executing the application itself may be configured to side-step such selections based on its awareness of the operating conditions. For example, when the mobile device is charging at night, the processor executing the application may determine the application may be configured to operate with a high-performance software configuration as selected by a user input only until the device temperature reaches a dangerous level (e.g., hot enough to burn the table on which the mobile device is resting, etc.). As another example, when the processor executing the application determines the battery may be depleted and there is no usage history stored that indicates the user typically charges the mobile device at a certain time of day, the processor executing the application may configure itself with an economic software configuration instead of a user-chosen high-performance software configuration.

In other embodiments, the user input may indicate a priority of possible software configurations that may be used by the application. For example, for each application and/or task that may be performed by each application executing on the processor of the mobile device, the user may choose the priority of each of the plurality of software configurations for the application. In this way, when the processor executing the application determines it may change its software configuration based on obtained operating conditions, subsequent user inputs, and/or when there are multiple concurrent applications executing on the mobile device, the processor executing the application may use the prioritized list of software configurations to select a next software configuration. In some embodiments, such a priority list of the software configurations may be further refined by the processor executing the application based on stored data indicating the last time a particular type of tasks (or task identity) was executed by the processor executing the application and/or the least amount of time this job may require.

In some embodiments, the second software configuration may cause greater device resource consumption (e.g., power, communication interfaces, bandwidth, etc.) that may deprive other applications of resources and thus impede their performance. Accordingly, in optional block 954, the processor executing the application may display a warning message when the second software configuration may utilize more mobile device resources than the first software configuration. For example, as illustrated in FIG. 9B above, the mobile device may render a pop-up or dialog box that indicates performance of the processor executing the application and/or the mobile device may change as a result of the switch from the first to the second software configuration. Similar to the operations described above with reference to block 206, in block 956, the processor executing the application may configure the application with the second software configuration. For example, the processor executing the application may utilize new operating parameters, new thresholds used for checking operating conditions, and/or access device resources differently. In block 958, the processor executing the application may process data using the application configured with the second software configuration.

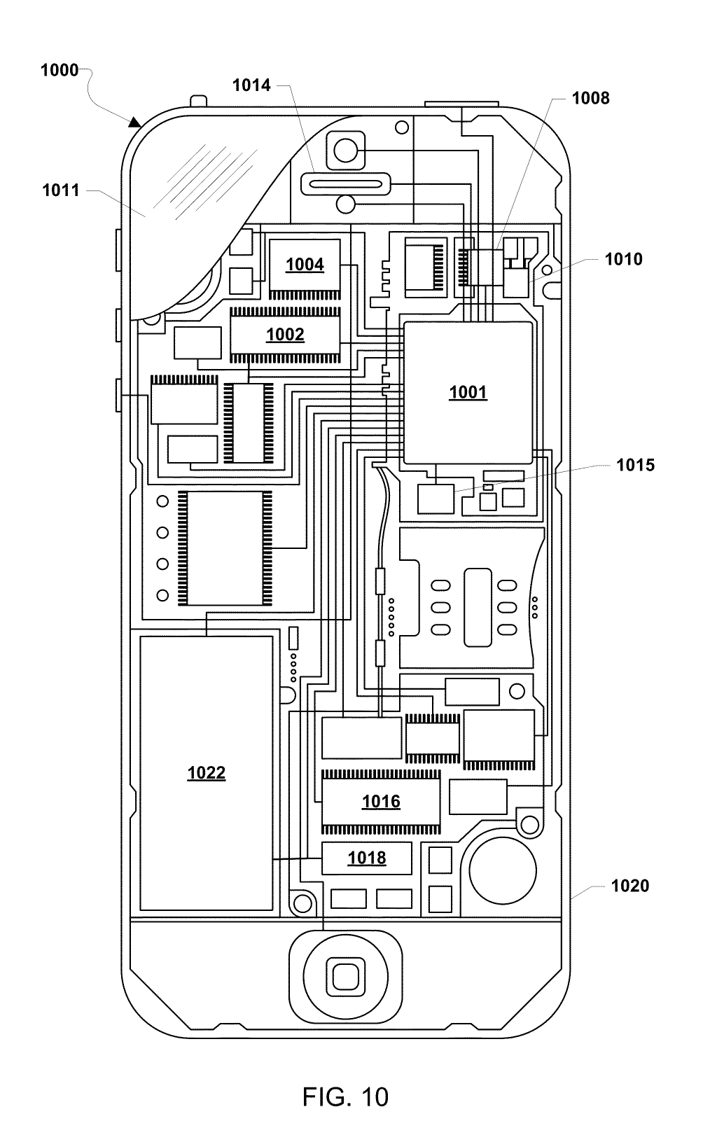

Various forms of mobile computing devices, including smartphones, tablets, and laptop computers, may be used to implement the various embodiments. Such mobile computing devices may typically include the components illustrated in FIG. 10 which illustrates an exemplary smartphone-type mobile device 1000. In various embodiments, the mobile device 1000 may include a processor 1001 coupled to a touchscreen controller 1004 and an internal memory 1002. The processor 1001 may be one or more multicore ICs designated for general or specific processing tasks. The internal memory 1002 may be volatile or non-volatile memory, and may also be secure and/or encrypted memory, or unsecure and/or unencrypted memory, or any combination thereof. The touchscreen controller 1004 and the processor 1001 may also be coupled to a touchscreen panel 1011, such as a resistive-sensing touchscreen, capacitive-sensing touchscreen, infrared sensing touchscreen, etc.

The mobile device 1000 may have one or more transceiver signal transceivers 1008 (e.g., Peanut®, Bluetooth®, Zigbee®, Wi-Fi, RF transceiver, etc.) and antennae 1010, for sending and receiving, coupled to each other and/or to the processor 1001. The transceivers 1008 and antennae 1010 may be used with the above-mentioned circuitry to implement the various wireless transmission protocol stacks and interfaces. The mobile device 1000 may include a cellular network wireless modem chip 1016 that enables communication via a cellular network and is coupled to the processor.

The mobile device 1000 may include a peripheral computing device connection interface 1018 coupled to the processor 1001. The peripheral computing device connection interface 1018 may be singularly configured to accept one type of connection, or multiply configured to accept various types of physical and communication connections, common or proprietary, such as USB, FireWire, Thunderbolt, or PCIe. The peripheral computing device connection interface 1018 may also be coupled to a similarly configured peripheral computing device connection port (not shown).

The mobile device 1000 may also include speakers 1014 for providing audio outputs. The mobile device 1000 may also include a housing 1020, constructed of a plastic, metal, or a combination of materials, for containing all or some of the components discussed herein. The mobile device 1000 may include a power source 1022 coupled to the processor 1001, such as a disposable or rechargeable battery. The power source 1022 may also be coupled to the peripheral computing device connection interface 1018 to receive a charging current from a source external to the mobile device 1000. Additionally, the mobile device 1000 may include a GPS receiver chip 1015 coupled to the processor 1001.

The processor 1001 may be any programmable microprocessor, microcomputer or multiple processor chip or chips that can be configured by software instructions (applications) to perform a variety of functions, including the functions of the various embodiments described above. In the various computing devices, multiple processors may be provided, such as one processor dedicated to wireless communication functions and one processor dedicated to running other applications. Typically, software applications may be stored in the internal memory 1002 before they are accessed and loaded into the processor 1001. The processor 1001 may include internal memory sufficient to store the application software instructions. In many computing devices the internal memory may be a volatile or nonvolatile memory, such as flash memory, or a mixture of both. For the purposes of this description, a general reference to memory refers to memory accessible by the processor 1001 including internal memory or removable memory plugged into the various computing devices and memory within the processor 1001.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic computing device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable storage medium (or computer-readable storage medium). The steps of a method or algorithm disclosed herein may be embodied in a processor-executable software module or processor-executable instructions (or processor-executable software instructions) which may reside on a non-transitory processor-readable storage medium (or a non-transitory computer-readable storage medium). Non-transitory processor-readable storage media may be any available media that may be accessed by a computing device. By way of example, and not limitation, such non-transitory processor-readable media may comprise RAM, ROM, EEPROM, CD-ROM or other optical disk storage, magnetic disk storage or other magnetic storage computing devices, or any other medium that may be used to store desired program code in the form of instructions or data structures and that may be accessed by a computing device. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory processor-readable media. Additionally, the operations of a method or algorithm may reside as one or any combination or set of codes and/or instructions on a non-transitory processor-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for improving user experience, energy consumption, and performance of a mobile device by automatically and dynamically configuring applications, comprising:
obtaining, by a processor executing an application, operating conditions of the mobile device using an application programming interface;
identifying, by the processor, a first software configuration of a plurality of software configurations based on the obtained operating conditions of the mobile device, wherein each in the plurality of software configurations define a set of operating parameters for the processor executing the application;
activating, by the processor, the first software configuration with respect to the application;
obtaining, by the processor, a first portion of a task shared between a plurality of nearby collaborating devices based on the activated first software configuration, wherein the task is processing data collectively stored across the plurality of nearby collaborating devices; and
performing, by the processor, the first portion of the task using the application configured with the activated first software configuration.

2. The method of claim 1, wherein the obtained operating conditions include one or more of available power conditions, battery conditions, temperature conditions, available communication protocols, available networking interfaces, network connectivity, past usage data, and processor workload.

3. The method of claim 1, wherein performing, by the processor, the first portion of the task using the application configured with the activated first software configuration comprises one of:
performing, by the processor, the operations of the first portion of the task in a shortest time period;
performing, by the processor, the operations of the first portion of the task until a predetermined threshold is exceeded, wherein the predetermined threshold relates to one of a battery level, a temperature of the mobile device, and a location of the mobile device; and
performing, by the processor, the operations of the first portion of the task in a fixed time period or periodically.

4. The method of claim 3, wherein performing, by the processor, the first portion of the task using the application configured with the activated first software configuration comprises exchanging data with one or more of the plurality of nearby collaborating devices using a preferred communication protocol.

5. The method of claim 1, further comprising receiving, by the processor, a command signal related to the task shared between the plurality of nearby collaborating devices, wherein the command signal instructs a change of an active software configuration based on the operating conditions.

6. The method of claim 5, further comprising:
deactivating, by the processor, the first software configuration with respect to the application in response to receiving the command signal;
activating, by the processor, a second software configuration with respect to the application in response to the processor deactivating the first software configuration; and
obtaining, by the processor, a second portion of the task shared between the plurality of nearby collaborating devices to be processed by the processor using the application configured with the second software configuration.

7. The method of claim 6, wherein the second software configuration utilizes a different communication protocol than the first software configuration.

8. A mobile device, comprising:
a processor configured with processor-executable instructions to perform operations comprising:
obtaining, operating conditions of the mobile device using an application programming interface;
identifying a first software configuration of a plurality of software configurations based on the obtained operating conditions of the mobile device, wherein each in the plurality of software configurations define a set of operating parameters for an application;
activating the first software configuration with respect to the application;
obtaining a first portion of a task shared between a plurality of nearby collaborating devices based on the activated first software configuration, wherein the task is processing data collectively stored across the plurality of nearby collaborating devices; and
performing the first portion of the task using the application configured with the activated first software configuration.

9. The mobile device of claim 8, wherein the obtained operating conditions include one or more of available power conditions, battery conditions, temperature conditions, available communication protocols, available networking interfaces, network connectivity, past usage data, and processor workload.

10. The mobile device of claim 8, wherein the processor is configured with processor-executable instructions to perform operations such that performing the first portion of the task using the application configured with the activated first software configuration comprises one of:
performing the operations of the first portion of the task in a shortest time period;
performing the operations of the first portion of the task until a predetermined threshold is exceeded, wherein the predetermined threshold relates to one of a battery level and a temperature of the mobile device; and
performing the operations of the first portion of the task in a fixed time period.

11. The mobile device of claim 10, wherein the processor is configured with processor-executable instructions to perform operations such that performing the first portion of the task using the application configured with the activated first software configuration comprises exchanging data with one or more of the plurality of nearby collaborating devices using a preferred communication protocol.

12. The mobile device of claim 8, wherein the processor is configured with processor-executable instructions to perform operations further comprising receiving a command signal related to the task shared between the plurality of nearby collaborating devices, wherein the command signal instructs a change of an active software configuration based on the operating conditions.

13. The mobile device of claim 12, wherein the processor is configured with processor-executable instructions to perform operations further comprising:
deactivating the first software configuration with respect to the application in response to receiving the command signal;
activating a second software configuration with respect to the application in response to deactivating the first software configuration; and
obtaining a second portion of the task shared between the plurality of nearby collaborating devices to be processed using the application configured with the second software configuration.

14. The mobile device of claim 13, wherein the second software configuration utilizes a different communication protocol than the first software configuration.

15. A system, comprising:
a first mobile device within a plurality of nearby collaborating devices,
wherein the first mobile device comprises a first processor configured with processor-executable instructions to perform operations comprising:
obtaining operating conditions of the first mobile device using an application programming interface;
identifying a first software configuration of a plurality of software configurations based on the obtained operating conditions of the first mobile device, wherein each in the plurality of software configurations define a set of operating parameters for an application;
activating the first software configuration with respect to the application;
obtaining a first portion of a task shared between the plurality of nearby collaborating devices based on the activated first software configuration, wherein the task is processing data collectively stored across the plurality of nearby collaborating devices; and
performing the first portion of the task using the application configured with the activated first software configuration.

16. The system of claim 15, wherein the obtained operating conditions include one or more of available power conditions, battery conditions, temperature conditions, available communication protocols, available networking interfaces, network connectivity, past usage data, and processor workload.

17. The system of claim 15, wherein the first processor is configured with processor-executable instructions to perform operations such that performing the first portion of the task using the application configured with the activated first software configuration comprises one of:
performing the operations of the first portion of the task in a shortest time period;
performing the operations of the first portion of the task until a predetermined threshold is exceeded, wherein the predetermined threshold relates to one of a battery level and a temperature of the first mobile device; and
performing the operations of the first portion of the task in a fixed time period.

18. The system of claim 17, wherein the first processor is configured with processor-executable instructions to perform operations such that performing the first portion of the task using the application configured with the activated first software configuration comprises exchanging data with one or more of the plurality of nearby collaborating devices using a preferred communication protocol.

19. The system of claim 15, further comprising:
a second mobile device within the plurality of nearby collaborating devices, the second mobile device comprising a second processor configured with processor-executable instructions to perform operations comprising:
transmitting a command signal related to the task shared between the plurality of nearby collaborating devices, wherein the command signal instructs a change of an active software configuration based on the operating conditions, and
wherein the first processor is configured with processor-executable instructions for performing operations further comprising:
receiving the command signal;
deactivating the first software configuration with respect to the application in response to receiving the command signal;
activating a second software configuration with respect to the application in response to deactivating the first software configuration; and
obtaining a second portion of the task shared between the plurality of nearby collaborating devices to be processed using the application configured with the second software configuration.

20. The system of claim 19, wherein the second software configuration utilizes a different communication protocol than the first software configuration.
